(19) United States
(12) Patent Application Publication
(10) Pub. No.: US 2026/0091568 A1
(43) Pub. Date: Apr. 2, 2026

(54) METHOD AND SYSTEM FOR FORMING A CONTAINER WITH INSULATING FEATURES

(71) Applicant: Graphic Packaging International, LLC, Atlanta, GA (US)

(72) Inventors: Adithya Challapalli, Menomonee Falls, WI (US); Kosaraju Mohan, Menomonee Falls, WI (US)

(21) Appl. No.: 19/394,954

(22) Filed: Nov. 20, 2025

Related U.S. Application Data
(63) Continuation-in-part of application No. 19/171,939, filed on Apr. 7, 2025.
Application No. 19/171,939 is a continuation of application No. 18/135,854, filed on Apr. 18, 2023, now Pat. No. 12,291,003.
Application No. 18/135,854 is a continuation-in-part of application No. 17/723,802, filed on Apr. 19, 2022, now Pat. No. 11,945,641.
Application No. 17/723,802 is a continuation-in-part of application No. 16/382,265, filed on Apr. 12, 2019, now Pat. No. 11,401,100.
Application No. 17/723,802 is a continuation-in-part of application No. 16/382,270, filed on Apr. 12, 2019, now Pat. No. 11,738,932.
(60) Provisional application No. 62/657,246, filed on Apr. 13, 2018.
(60) Provisional application No. 62/657,246, filed on Apr. 13, 2018.
(60) Provisional application No. 62/674,834, filed on May 22, 2018.
(60) Provisional application No. 62/674,834, filed on May 22, 2018.
(60) Provisional application No. 62/794,131, filed on Jan. 18, 2019.
(60) Provisional application No. 62/794,131, filed on Jan. 18, 2019.
(60) Provisional application No. 63/333,710, filed on Apr. 22, 2022.
(60) Provisional application No. 63/723,807, filed on Nov. 22, 2024.

(51) Int. Cl. B31B 50/62; B31B 50/02; B31B 105/00; B31B 110/10; B31B 120/40; B65D 3/06; B65D 3/14; B65D 81/38

(52) U.S. Cl. CPC B31B 50/626; B31B 50/024; B65D 3/06; B65D 3/14; B65D 81/3869; B31B 2105/0022; B31B 2110/10; B31B 2120/40

(57) ABSTRACT

Disclosed are a container for containing a cold or hot fluid and methods of forming said container. The container includes a sidewall construct including an inner sidewall extending at least partially around an interior of the container, an outer sleeve attached to the inner sidewall, and an air gap defined between the inner sidewall and outer sleeve. The width of the air gap is defined by a plurality of adhesive layers applied as successive annular beads to the inner sidewall. Methods can be employed to maximize the bead height of at least one of the adhesive layers to form the desired width of the air gap while maintaining adhesion properties and minimizing the amount of adhesive material used. Bead height for each layer can be optimized by controlling the type of adhesive material used, the application rate and temperature, the application angle, the cooling rate, and the dwell time.

### CROSS-REFERENCE TO RELATED APPLICATIONS

This application claims the benefit of U.S. Provisional Patent Application No. 63/723,807 filed Nov. 22, 2024. This application is a continuation in part of U.S. patent application Ser. No. 19/171,939, filed Apr. 7, 2025 which is a continuation of U.S. patent application Ser. No. 18/135,854, filed Apr. 18, 2023, now U.S. Pat. No. 12,291,003, which is a continuation in part of U.S. patent application Ser. No. 17/723,802, filed Apr. 19, 2022, now U.S. Pat. No. 11,945,641, which is a continuation-in-part of U.S. patent application Ser. No. 16/382,265, filed Apr. 12, 2019, now U.S. Pat. No. 11,401,100, which claims the benefit of each of U.S. Provisional Patent Application No. 62/657,246, filed on Apr. 13, 2018, U.S. Provisional Patent Application No. 62/674,834, filed on May 22, 2018, and U.S. Provisional Patent Application No. 62/794,131, filed on Jan. 18, 2019, and U.S. patent application Ser. No. 17/723,802 which is a continuation-in-part of U.S. patent application Ser. No. 16/382,270, filed Apr. 12, 2019 which claims the benefit of each of U.S. Provisional Patent Application No. 62/657,246, filed on Apr. 13, 2018, U.S. Provisional Patent Application No. 62/674,834, filed on May 22, 2018, and U.S. Provisional Patent Application No. 62/794,131, filed on Jan. 18, 2019. U.S. patent application Ser. No. 18/135,854 also claims the benefit of U.S. Provisional Patent Application No. 63/333,710, filed on Apr. 22, 2022.

### INCORPORATION BY REFERENCE

The disclosures of each of U.S. patent application Ser. No. 19/171,939, filed Apr. 7, 2025, U.S. patent application Ser. No. 18/135,854 filed Apr. 18, 2023, now U.S. Pat. No. 12,291,003, U.S. patent application Ser. No. 17/723,802, filed Apr. 19, 2022, now U.S. Pat. No. 11,945,641, U.S. patent application Ser. No. 16/382,265, filed Apr. 12, 2019, now U.S. Pat. No. 11,401,100, U.S. patent application Ser. No. 16/382,270, filed Apr. 12, 2019, U.S. Provisional Patent Application No. 62/657,246, filed on Apr. 13, 2018, U.S. Provisional Patent Application No. 62/674,834, filed on May 22, 2018, U.S. Provisional Patent Application No. 62/794,131, filed on Jan. 18, 2019, U.S. Provisional Patent Application No. 63/333,710, filed on Apr. 22, 2022, and U.S. Provisional Patent Application No. 63/723,807, filed on Nov. 22, 2024 are hereby incorporated by reference for all purposes as if presented herein in their entirety.

### BACKGROUND OF THE DISCLOSURE

The present disclosure generally relates to containers for containing fluid, for example, beverage containers. In one embodiment, the present disclosure relates to a container formed from a sidewall and having insulating features sufficient to maintain a desired temperature of a cold or hot beverage, and/or one or more surface conditions of the container.

### SUMMARY OF THE DISCLOSURE

According to one aspect of the disclosure, a container for containing a cold or hot fluid comprises a sidewall construct comprising an inner sidewall extending at least partially around an interior of the container, an outer sleeve attached to the inner sidewall, and a cavity defined between the inner sidewall and the outer sleeve. The container further comprises a closed bottom defining a bottom of the interior of the container. The container further comprises insulating features comprising the cavity and a plurality of annular bands, each annular band of the plurality of annular bands comprises a spacer that extends in the cavity from the inner sidewall to the outer sleeve. Adjacent bands define a respective pocket of a plurality of pockets in the cavity such that the insulating features maintain a desired temperature of the cold or hot fluid.

According to another aspect of the disclosure, a sidewall construct for forming a fluid container for containing a cold or hot fluid comprises an inner sidewall extending at least partially around an interior of the container, an outer sleeve attached to the inner sidewall, a cavity defined between the inner sidewall and the outer sleeve, and insulating features comprising the cavity and a plurality of annular bands. Each band of the plurality of annular bands comprises a spacer that extends in the cavity from the inner sidewall to the outer sleeve, and adjacent bands define a respective pocket of a plurality of pockets in the cavity for maintaining a desired temperature of the cold or hot fluid.

According to another aspect of the disclosure, a method of forming a container for containing a cold or hot fluid comprises obtaining an inner sidewall and an outer sleeve, and attaching the outer sleeve to the inner sidewall to form a sidewall construct with a cavity defined between the inner sidewall and the outer sleeve. The attaching comprises forming insulating features in the sidewall construct, the insulating features comprise the cavity and a plurality of annular bands, each annular band of the plurality of annular bands comprises a spacer that extends in the cavity from the inner sidewall to the outer sleeve, adjacent bands define a respective pocket of a plurality of pockets in the cavity for maintaining a desired temperature of the cold or hot fluid. The method further comprises forming an interior of the container by positioning the sidewall construct so that the inner sidewall extends at least partially around the interior. The method further comprises positioning a closed bottom relative to the sidewall construct.

According to another aspect of the disclosure, a method of forming a container for containing a cold or hot fluid comprises obtaining a base container having an inner sidewall and a bottom secured to the inner sidewall, and the inner sidewall extending at least partially around an interior that defines an interior volume of the container. The method comprises forming a plurality of annular bands on the inner sidewall of the base container. The forming the plurality of annular bands comprises applying a first layer of material to the inner sidewall and a second layer of material to the first layer of material. The method comprises obtaining an outer sleeve and attaching the outer sleeve to the inner sidewall to form a sidewall construct of the container with insulating features defined between the inner sidewall and the outer sleeve. The attaching the outer sleeve comprises pressing the outer sleeve against the plurality of annular bands to adhesively secure the outer sleeve to the inner sidewall. The insulating features comprise a cavity between the inner sidewall and the outer sleeve, the plurality of annular bands, and a plurality of pockets in the cavity formed between adjacent annular bands. The insulating features are for maintaining a desired temperature of the cold or hot fluid in the interior volume of the container.

According to another aspect of the disclosure, a system for forming a container for containing a cold or hot fluid comprises a base container forming machine for forming a base container having an inner sidewall, a bottom secured to the inner sidewall, the inner sidewall extends at least partially around an interior that defines an interior volume of the container. The system comprises an intermediate container forming machine for receiving the base container from the base container forming machine and forming an intermediate container. The intermediate container forming machine has a first material applicator for applying a first layer of material to the inner sidewall of the base container and a second material applicator for applying a second layer of material to the first layer of material to form a plurality of annular bands on the inner sidewall of the base container, the intermediate container comprises the first layer of material and second layer of material applied to the base container. The system comprises an outer sleeve attachment machine for receiving the intermediate container and attaching an outer sleeve to the intermediate container.

According to another aspect of the disclosure, a system for forming a container for containing a cold or hot fluid, an intermediate container forming machine for receiving a base container from a base container forming machine, the base container having an inner sidewall, a bottom secured to the inner sidewall, the inner sidewall extends at least partially around an interior that defines an interior volume of the container, the intermediate container forming machine being for forming an intermediate container and discharging the intermediate container to an outer sleeve forming machine. The intermediate container forming machine comprising a turret assembly for receiving the base container and moving the base container within the intermediate container forming machine, a first material applicator for applying a first layer of material to the inner sidewall of the base container, and a second material applicator for applying a second layer of material to the first layer of material. The intermediate container forming machine comprises a discharge station for discharging the intermediate container to an outer sleeve attachment machine. The intermediate container comprises the first layer of material and second layer of material applied to the base container to form a plurality of annular bands on the inner sidewall of the base container.

According to another aspect of the disclosure, a container for containing a cold fluid, the container comprises a sidewall construct comprising an inner sidewall extending at least partially around an interior of the container, an outer sleeve attached to the inner sidewall, and a cavity defined between the inner sidewall and the outer sleeve, and a closed bottom defining a bottom of the interior of the container. The container comprises insulating features comprising the cavity and a plurality of annular bands, each annular band of the plurality of annular bands comprises a spacer that extends in the cavity from the inner sidewall to the outer sleeve, the spacer comprises an inner layer of material in adhesive contact with the inner sidewall, an outer layer of material in adhesive contact with outer sleeve, and at least one intermediate layer of material applied between the inner layer and the outer layer. The inner layer and the outer layer comprise a higher temperature hotmelt adhesive and the intermediate layer comprises a lower temperature hotmelt adhesive, and adjacent bands define a respective pocket of a plurality of pockets in the cavity such that the insulating features maintain a desired temperature of the cold fluid.

According to another aspect of the disclosure, a sidewall construct for forming a fluid container for containing a cold fluid comprises an inner sidewall extending at least partially around an interior of the container; an outer sleeve attached to the inner sidewall, a cavity defined between the inner sidewall and the outer sleeve, and insulating features. The insulating features comprising the cavity and a plurality of annular bands. Each annular band of the plurality of annular bands comprises a spacer that extends in the cavity from the inner sidewall to the outer sleeve, the spacer comprises an inner layer of material in adhesive contact with the inner sidewall, an outer layer of material in adhesive contact with outer sleeve, and at least one intermediate layer of material applied between the inner layer and the outer layer. The inner layer and the outer layer comprise a higher temperature hotmelt adhesive and the intermediate layer comprises a lower temperature hotmelt adhesive, and adjacent bands define a respective pocket of a plurality of pockets in the cavity for maintaining a desired temperature of the cold fluid.

According to another aspect of the disclosure, a method of forming a container for containing a cold fluid comprises obtaining an inner sidewall and an outer sleeve, attaching the outer sleeve to the inner sidewall to form a sidewall construct with a cavity defined between the inner sidewall and the outer sleeve. The attaching comprises forming insulating features in the sidewall construct. The insulating features comprise the cavity and a plurality of annular bands, each annular band of the plurality of annular bands comprises a spacer that extends in the cavity from the inner sidewall to the outer sleeve. The spacer comprises an inner layer of material in adhesive contact with the inner sidewall, an outer layer of material in adhesive contact with outer sleeve, and at least one intermediate layer of material applied between the inner layer and the outer layer. The inner layer and the outer layer comprise a higher temperature hotmelt adhesive and the intermediate layer comprises a lower temperature hotmelt adhesive. Adjacent bands define a respective pocket of a plurality of pockets in the cavity for maintaining a desired temperature of the cold fluid. The method comprises forming an interior of the container by positioning the sidewall construct so that the inner sidewall extends at least partially around the interior and positioning a closed bottom relative to the sidewall construct.

According to common practice, the various features of the drawings discussed below are not necessarily drawn to scale. Dimensions of various features and elements in the drawings may be expanded or reduced to more clearly illustrate the embodiments of the disclosure.

### BRIEF DESCRIPTION OF THE DRAWINGS

FIG. 1 is a perspective view of a container according to a first exemplary embodiment of the disclosure.

FIG. 2 is a schematic cross-sectional view of the container of FIG. 1.

FIG. 3 is a front view of the container of FIG. 1 with an outer sleeve removed.

FIG. 4 is a schematic cross-sectional view of a portion of a sidewall construct of the container of FIG. 1.

FIG. 5 is a perspective view of a container according to a second exemplary embodiment of the disclosure.

FIG. 6 is a schematic cross-sectional view of the container of FIG. 5.

FIG. 7A is a schematic cross-sectional view of a pair of containers, each as shown in FIG. 1, in a nested arrangement.

FIG. 7B is a schematic cross-sectional view of a pair of containers, each as shown in FIG. 6, in a nested arrangement.

FIG. 7C is an enlarged portion of FIG. 7B.

FIG. 8 is a schematic cross-sectional view of a container according to a third exemplary embodiment of the disclosure.

FIG. 9 is a schematic cross-sectional view of a portion of a sidewall construct of the container of FIG. 8.

FIG. 10 is a schematic cross-sectional view of a pair of containers, each as shown in FIG. 8 in a nested arrangement.

FIG. 10A is an enlarged portion of FIG. 10.

FIG. 10B is a view similar to FIG. 8 with a closed bottom of the container at an alternative position.

FIG. 11 is a schematic cross-sectional view of a container according to a fourth exemplary embodiment of the disclosure.

FIG. 12 is a schematic cross-sectional view of a portion of a sidewall construct of the container of FIG. 11.

FIG. 13 is a schematic cross-sectional view of a pair of containers, each as shown in FIG. 11 in a nested arrangement.

FIG. 13A is an enlarged portion of FIG. 13.

FIG. 13B is a view similar to FIG. 11 with a closed bottom of the container at an alternative position.

FIG. 14 is a process flow illustrating a system for forming containers according to an exemplary embodiment of the present disclosure.

FIG. 15 is a perspective view of an intermediate container forming machine of the system of FIG. 14 according to an exemplary embodiment of the disclosure.

FIG. 16 is a perspective view of an isolated portion of the intermediate container forming machine of FIG. 15 according to an exemplary embodiment of the disclosure.

FIG. 17 is a perspective view of an isolated portion of the intermediate container forming machine of FIG. 15 in operation according to an exemplary embodiment of the disclosure.

FIG. 18 is an enlarged view of a portion of FIG. 17.

FIG. 19 is an enlarged view of another portion of FIG. 17.

FIG. 20 is an enlarged view of another portion of FIG. 17.

FIG. 21 is a perspective view of an outer sleeve attachment machine of the system of FIG. 14 and in operation according to an exemplary embodiment of the disclosure.

FIG. 22 is an enlarged view of a portion of FIG. 21.

FIG. 23 is an enlarged view of another portion of FIG. 21.

FIG. 24 is a perspective view of another example embodiment of a container with the outer sleeve removed.

FIG. 25 is a plot of data showing the viscosity-temperature relationship for example hotmelt adhesives used for the adhesive beads.

FIG. 26A is a schematic cross-sectional view of an adhesive bead applied to a container according to embodiments of the disclosure.

FIG. 26B is another schematic cross-sectional view of an adhesive bead applied to a container according to embodiments of the disclosure.

FIG. 27 is a plot of data showing the relationship between application angle of the adhesive bead and the adhesive bead height.

FIG. 28 is another schematic cross-sectional view of an adhesive bead applied to an example container with forced cooling according to embodiments of the disclosure.

FIG. 29 is a schematic cross-sectional view of a portion of an embodiment of a sidewall construct of an example container.

FIG. 30 is an enlarged view of Detail “A1” of FIG. 29.

FIG. 31 is a schematic cross-sectional view of a portion of another embodiment of a sidewall construct of an example container.

FIG. 32 is an enlarged view of Detail “A1” of FIG. 31.

Corresponding parts are designated by corresponding reference numbers throughout the drawings.

### DETAILED DESCRIPTION OF THE EXEMPLARY EMBODIMENTS

Containers according to the present disclosure can accommodate fluids, e.g., liquid or semi-liquid beverages that can include one or more solid components, of different sizes and compositions. For the purpose of illustration and not for the purpose of limiting the scope of the disclosure, the following detailed description describes a container for cold or hot fluids. It will be understood that the containers described herein can hold different types of beverages and/or products containing one or more food items without departing from the disclosure.

In this specification, the terms “lower,” “bottom,” “upper,” and “top” indicate orientations determined in relation to fully erected and upright containers. As described herein, containers can be formed from blanks by overlapping multiple portions, panels, and/or end flaps. Such portions, panels, and/or end flaps may be designated herein in terms relative to one another, e.g., “first”, “second”, “third”, etc., in sequential or non-sequential reference, without departing from the disclosure.

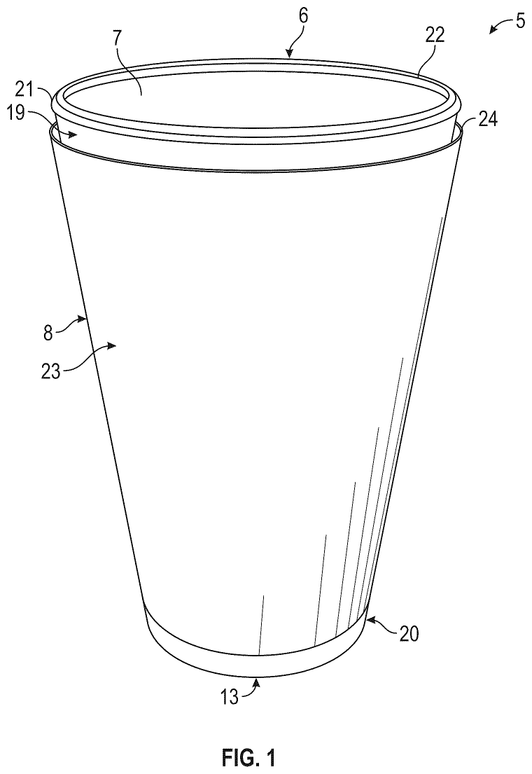

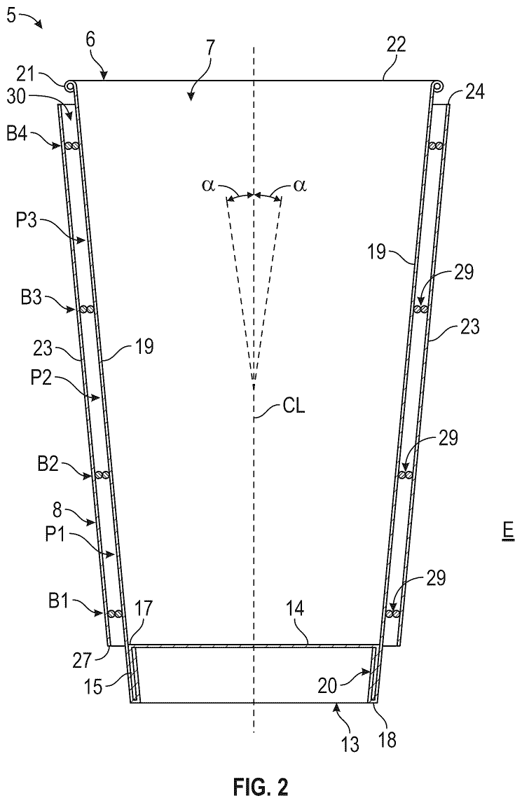

FIG. 1 is a perspective view, and FIG. 2 is a cross-sectional view, of a container 5 according to a first exemplary embodiment of the disclosure. In one embodiment, the container 5 is a cup having the general shape of a truncated cone with an open top 6, a closed bottom 13, and a sidewall construct 8 extending from a bottom edge to a top edge of the container 5. The closed bottom 13 and sidewall construct 8 define and extend at least partially around an interior space 7 (FIG. 2) of the container 5 with an interior volume that is for holding fluid.

In the illustrated embodiment, the sidewall construct 8 comprises an annular inner sidewall 19 (broadly, “inner wall”) and an outer sleeve 23 (broadly, “outer wall”) attached to the inner sidewall 19 such that the sidewall construct 8 can be referred to as a double wall structure. In one embodiment, one or both of the inner sidewall 19 and the sleeve 23 can be formed of paperboard, having one or more surface provided with, for example, a thermoplastic coating. Such paperboard can be provided with one or more desired surface features, for example, ribs or ridges, such as in fluted or corrugated paperboard. In one embodiment, the inner sidewall 19 can have a thickness of at least about 12 mil and the sleeve 23 can have a thickness of at least about 1 mil.

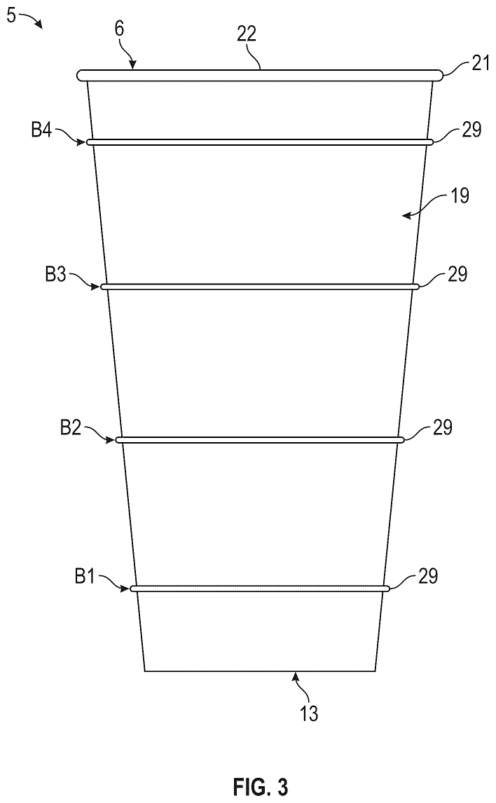

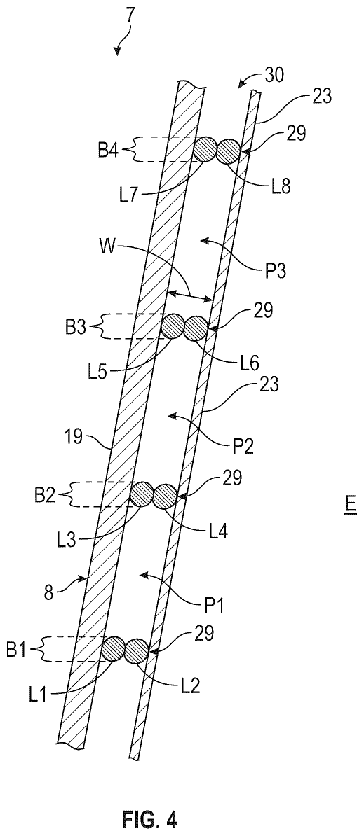

With additional reference to FIGS. 3 and 4, the container 5 includes insulating features in the sidewall construct 8 that include bands B1, B2, B3, B4 of spacers 29 that are circumferentially disposed at different vertical heights along the sidewall construct 8. The spacers 29 can be at least partially comprised of adhesive, such as a hotmelt glue or other glue, and extend from the inner sidewall 19 to the outer sleeve 23 to adhesively attach the outer sleeve 23 to the inner sidewall 19. In one embodiment, the spacers 29 can be formed from a different polymeric material. In this regard, in one embodiment, the adhesive that forms the spacers 29 can be set or cured to provide desired properties of the spacers 29. As discussed further below, the insulating features of the container 5 are arranged so that an insulation profile of the container 5 can be enhanced, for example, so that a selected or desired temperature or temperature range of the fluid in the container 5 is maintained, e.g., such that a rate of temperature increase toward an equilibrium temperature is within a selected or desired threshold, and/or so that one or more outer surface conditions of the container 5 can be maintained.

In one embodiment, the insulating features of the container 5 are arranged such that a relatively low temperature, e.g., a temperature at or below about approximately 40° F. (or any suitable temperature for a cold beverage) or a relatively high temperature, e.g., a temperature at or above about approximately 120° F. (or any suitable temperature for a hot beverage) fluid in the interior space 7 of the container 5 can be maintained, and such that the transfer of heat to the fluid in the interior space 7 from a surrounding environment E and/or a customer's hands can be substantially minimized, inhibited, and/or prevented. The insulating features of the container 5 additionally can maintain one or more surface conditions of the exterior surface of the sleeve 23 and/or exposed portions of the inner sidewall 19, for example, a surface temperature above the dew point of the surrounding environment such that condensation is minimized, inhibited, and/or prevented from forming on the container 5. In one embodiment, such condition can be maintained for up to and including about an hour or more. In this regard, a user can be provided with a more comfortable surface to grasp the container 5, e.g., such that the exterior surface of the outer sleeve 23 does not present or minimizes any temperature regions or zones that are uncomfortable to a customer's touch and/or a wet or slippery texture due to condensation. The container 5 can be provided with a different arrangement of insulating features without departing from the disclosure.

As shown, the bottom 13 of the container 5 includes a generally circular bottom panel 14 and an annular leg 15 downwardly-depending from the bottom panel 14 at a generally circular line of weakening 17. The bottom panel 14 has a diameter that generally corresponds to a horizontal distance between opposing sides of the inner sidewall 19. The inner sidewall 19 extends upwardly from the closed bottom 13 to define the interior space 7 of the container 5. The annular leg 15 is adhesively attached to a lower edge margin 20 of the inner sidewall 19 to secure the bottom 13 to the sidewall construct 8 and to form the bottom of the interior space 7 of the container 5. As shown, the lower edge margin 20 of the inner sidewall 19 extends along the outer surface of the annular leg 15, wraps under a lower edge thereof, and extends upwardly along the interior surface of the annular leg 15 toward the bottom panel 14. The lower edge margin 20 of the inner sidewall 19 can be an at least partially flexible portion of the inner sidewall 19 configured to engage the annular leg 15, and can include surface features to facilitate such engagement, for example, an adhesive treatment and/or frictionally-enhancing patterning. As described herein, the portion of the lower edge margin 20 of the inner sidewall 19 overlying the lower edge of the annular leg 15 will define an inner bottom edge or inner lower edge 18 of the inner sidewall 19. In one embodiment, the lower edge of the annular leg 15 can define the lower edge of the coupled inner sidewall 19 and the bottom 13.

The bottom 13 can be secured to the sidewall construct 8 in a different configuration without departing from the disclosure. For example, in one embodiment, the bottom 13 can be inserted into the interior space 7 formed by the sidewall construct 8 and coupled thereto, e.g., in the manner described above. In another embodiment, the bottom 13 and the annular leg 15 of the container 5 can be integrally formed with the inner sidewall 19 or can be otherwise attached to a portion of the inner sidewall 19 by other attachment means. In still another embodiment, the bottom 13 can be coupled to the inner sidewall 19 as described above, and the coupled inner sidewall 19/bottom 13 can be inserted into or otherwise coupled with the sleeve 23, e.g., via the spacers 29. In yet another embodiment, the sidewall construct 8 can be formed in a flat configuration, and then wrapped around and coupled to the bottom 13 in the manner described above.

As also shown, a top edge of the inner sidewall 19 is curved, curled, or otherwise flanged to define a top or upper rim 21 of the container 5 that circumscribes an opening 22 in communication with the interior space 7 of the container 5. The rim 21 and/or an upper portion of the container 5 can be configured to engage a lid or other top closure structure.

The illustrated configuration of the truncated conical shape of the container 5 can be achieved by forming the inner sidewall 19 from a flat blank by folding around a mandrel such that an overlapping seam is provided. The inner sidewall 19 (and the sleeve 23 disposed therearound), as shown, have a tapered configuration such that the inner sidewall 19 and the sleeve 23 extend at a constant angle α relative to a vertical centerline CL of the container 5.

Still referring to FIGS. 1-4, the outer sleeve or sleeve 23, e.g., a wrap or other layer, is disposed in at least partial circumferential engagement with the inner sidewall 19 such that the sleeve 23 presents an outer surface of the container 5 for engagement by a user. As shown, the sleeve 23 includes an upper edge 24 proximate the rim 21 and the sleeve 23 protrudes downwardly such that an outer bottom edge or outer lower edge 27 of the sleeve 23 is spaced above the lower edge 18 of the inner sidewall 19. In one embodiment, the lower edge 27 of the sleeve 23 is spaced above the lower edge 18 of the inner sidewall 19 by approximately the vertical length of the lower edge margin 20 such that the lower edge 27 of the sleeve 23 is substantially level with the bottom panel 14 of the bottom 13 of the container 5. In one embodiment, the lower edge 27 of the sleeve 23 can be approximately level with the lower edge 18 of the inner sidewall 19.

As described herein, at least the interface between the sleeve 23 and the inner sidewall 19 of the container 5 forms insulating features of the container 5 that include a cavity 30 defined between the inner wall 19 and the outer sleeve 23. In one embodiment, the insulating features of the container 5 can also include one or more portions of the inner sidewall 19 and/or the sleeve 23. Alternative insulating features are further described in U.S. Provisional Patent Application No. 62/657,246, filed on Apr. 13, 2018, and U.S. Provisional Patent Application No. 62/674,834, filed on May 22, 2018, the entire contents of each of which are incorporated by reference herein.

FIG. 3 is a front view of the container 5 with the sleeve 23 removed such that the inner sidewall 19 is visible. As shown, a plurality of annular bands B1, B2, B3, B4 of adhesive are applied between the inner sidewall 19 and the outer sleeve 23 to attach the outer sleeve 23 to the inner sidewall 19 and to form the spacers 29. In one embodiment, the annular bands B1, B2, B3, B4 are each a continuous pattern of adhesive to form respective continuous spacers 29. As shown in FIG. 4, the bands B1, B2, B3, B4 can each be comprised of two respective layers of adhesive L1, L2, L3, L4 and L5, L6, L7, L8 to form the spacers 29. As described above, the adhesive that forms the spacers 29 can be set or cured to provide desired properties of the spacers 29. In one embodiment, a respective first layer L1, L2, L3, L4 of adhesive can be applied to the outer surface of the sidewall construct 8 or to the interior surface of the sleeve 23, allowed to at least partially set or cure, and a respective second layer L5, L6, L7, L8 of adhesive can be applied thereon. In another embodiment, a single layer of adhesive can be applied at a desired thickness to form one or more of the bands B1, B2, B3, B4.

As described further below, one or more of the bands B1, B2, B3, B4 can be a continuous band of adhesive arranged between the inner sidewall 19 and the outer sleeve 23 such that an at least partial seal is provided, e.g., to minimize, inhibit, and/or prevent the passage of fluid thereby. In one embodiment, one or more of the bands B1 through B4 can have one or more discontinuities therealong, for example, to provide ventilation paths among the bands B1, B2, B3, B4 and/or an external environment E. It will be understood that a different numbers of bands of spacers 29 can be present without departing from the disclosure. In one embodiment, surface features such as bands, ridges, protrusions, etc., can be provided in at least partial circumferential engagement around the inner sidewall 19, and can provide a surface or substrate upon which the bands of adhesive that form the spacers 29 can applied. Such surface features can provide an optimal surface for the adhesive interface between the inner sidewall 19 and the sleeve 23.

As shown in FIGS. 2 and 4, a pocket P1 is defined in the cavity 30 between the inner sidewall 19 and the sleeve 23 between the band B1 and the band B2, a pocket P2 is defined in the cavity 30 between the inner sidewall 19 and the sleeve 23 between the band B2 and the band B3, and a pocket P3 is defined in the cavity 30 between the inner sidewall 19 and the sleeve 23 between the band B3 and the band B4. At least the pockets P1, P2, P3 provide insulating spaces or gaps between the inner sidewall 19 and the sleeve 23. As described, one or more of the pockets P1, P2, P3 can be a region in which fluid is at least partially held or sealed by the arrangement of the inner sidewall 19, the outer sleeve 23, and the respective bands B1, B2, B3, B4. In one embodiment, each pocket P1, P2, P3 can have a width W measured from the inner sidewall 19 to the outer sleeve 23 and at least partially determined by the size of the spacers 29, for example, between about 60 mils and about 120 mils, for example, about 60 mils, about 70 mils, about 80 mils, about 90 mils, about 100 mils, about 110 mils, about 120 mils, etc. or integer or non-integer numbers therebetween. In one embodiment, the width W can be about 80 mils. It will be understood the width W of the spacers 29 can be a different dimension without departing from the disclosure. The width W of the spacers 29 defines the relative spacing of the cavity 30 such that the pockets P1, P2, P3 can be configured as air gaps between the interior space 7 of the container 5 and an external environment E.

Such insulating features can resist a temperature change of fluid in the container 5 by resisting the transfer of heat from the external environment E surrounding the container 5 to the cavity 30, and further to a fluid in the interior space 7 of the container 5. In one embodiment, heat from the surrounding environment E can be at least partially transferred to air or other fluid that is trapped or otherwise maintained in one or more of the pockets P1, P2, P3 between the respective bands B1, B2, B3, B4 of spacers 29. The pockets P1, P2, P3 thus provide an additional buffer, e.g., a heat sink, between the interior space 7 of the container 5 and the surrounding environment E, in addition to the inner sidewall 19 and the outer sleeve 23. In addition to maintaining a temperature of a fluid in the interior space 7 of the container 5, such insulation provided by the arrangement of the spacers 29 can also maintain a desired surface temperature of the sleeve 23 to facilitate comfortable grasping by a customer and/or maintain one or more desired surface conditions of the sleeve 23, e.g., to minimize, inhibit, and/or prevent condensation as described above. Further still, the arrangement of the bands B1, B2, B3, B4 of spacers 29 can impart desired structural properties to the container 5, for example, by providing a desired pattern of rigidity such that an optimal pattern of flexion is provided to the container 5 during use. For example, upon grasping of the sidewall construct 8 by a customer, portions of the sleeve 23/inner sidewall 19 can bend or flex inwardly into one or more of the pockets P1, P2, P3 to provide a textured or irregular surface configuration to enhance the customer's grip on the container 5.

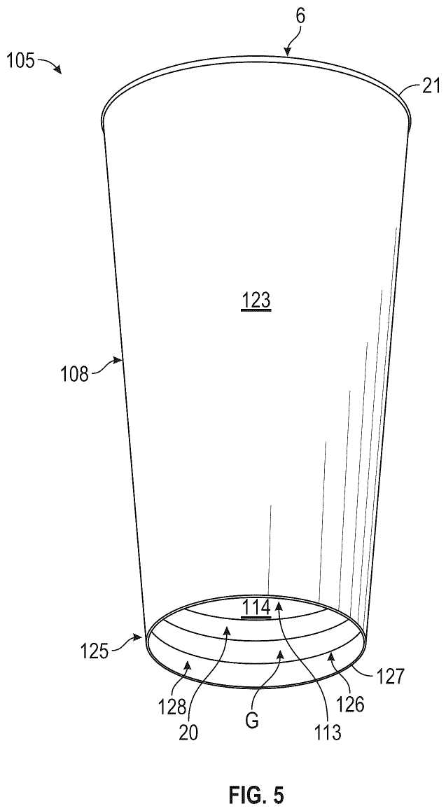

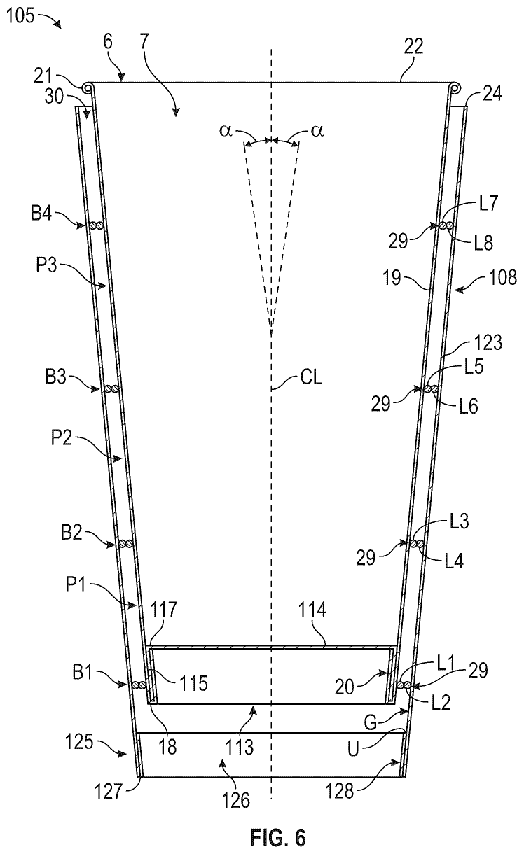

Referring additionally to FIGS. 5 and 6, a container 105 is illustrated according to a second exemplary embodiment of the disclosure. It will be understood that the container 105 can be a modification of the container 5 of the first exemplary embodiment of the disclosure. One or more portions of the container 105 are substantially similar to that of the container 5 of the first exemplary embodiment of the disclosure, and like or similar reference numbers will refer to such like or similar elements.

As shown, the container 105 includes the sidewall construct 108, which includes the inner sidewall 19 and an outer sleeve 123. Insulating features are disposed between the inner sidewall 19 and the outer sleeve 123 of the container 105 as described above with respect to the container 5. For example, and as shown, bands B1, B2, B3, B4 of spacers 29 can be disposed between the inner sidewall 19 and the outer sleeve 23, and define the respective pockets P1, P2, P3 therebetween.

The outer sleeve 23 extends downwardly past the lower edge 18 of the inner sidewall 19 to form an annular base 125 of the container 105 such that a lower portion of the outer sleeve 23 defines an interior annular recess 126 between the lower edge 127 of the annular base 125/container 105 and a bottom panel 114.

A lower edge margin 128 of the sleeve 23, as shown, is interiorly folded into the annular recess 125 into face-to-face contact with a lower portion of the outer sleeve 123/annular base 125 to define the lower edge 127 and to provide a two-ply structure at a bottom portion of the annular base 125 upon which the container 105 can rest in an upright orientation.

As also shown, the closed bottom 113, including the bottom panel 114 and an annular leg 115 foldably connected thereto at a line of weakening 117, are positioned a vertical distance above the lower edge 127 of the container 105, and an annular discontinuity or annular gap G is defined between the lower edge 18 of the inner sidewall 19 and an upper edge U of the lower edge margin 128 of the sleeve 23. In one embodiment, the annular gap G can provide a vent for one or more portions of the cavity 30.

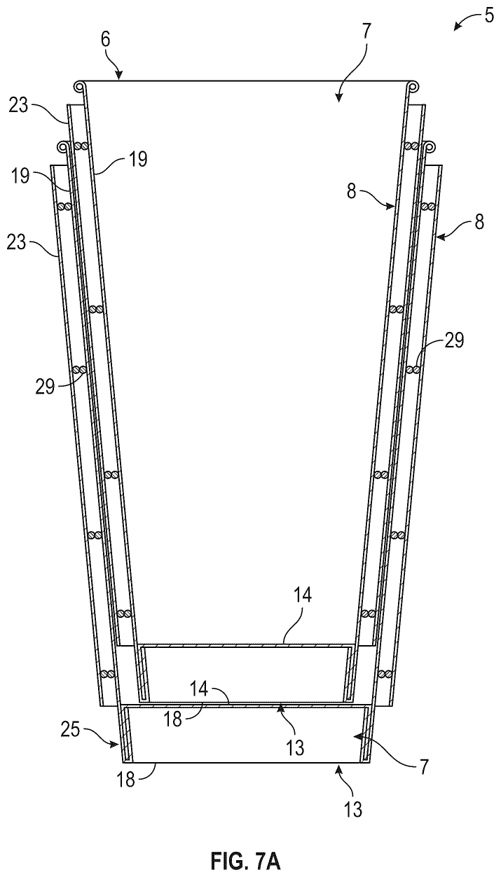

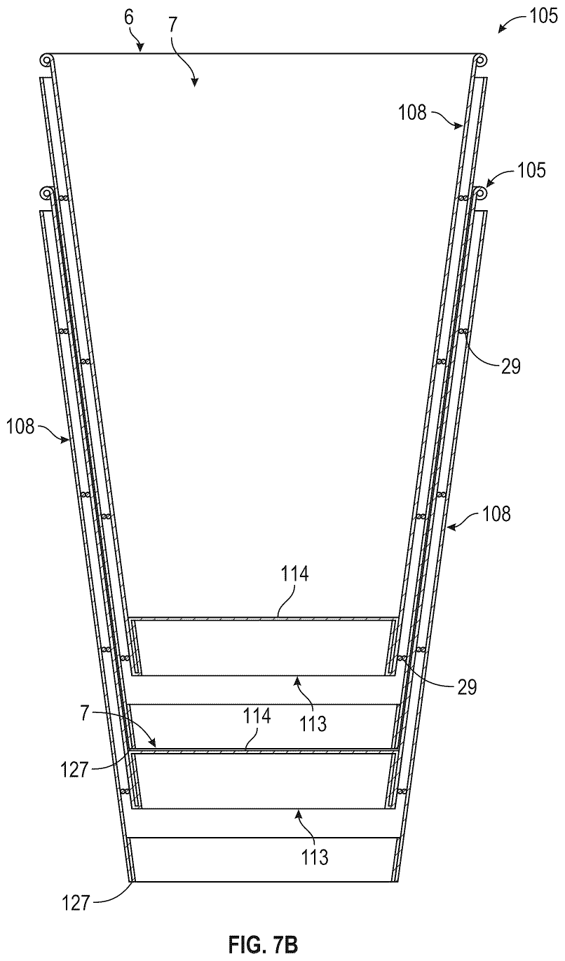

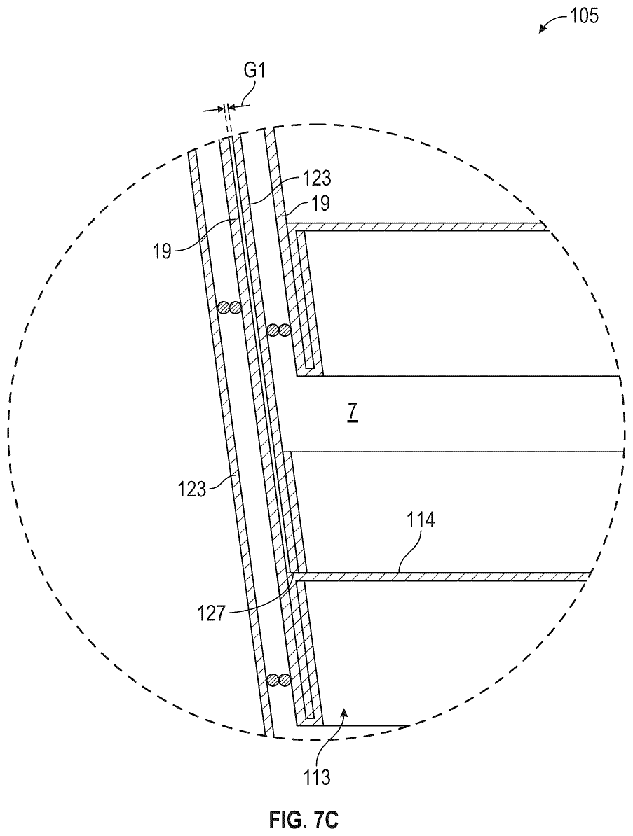

In one embodiment, the inner sidewall 19 and the sleeve 123, with insulating features therebetween, can be separately formed from the closed bottom 113, and so that the bottom 113 can be coupled to the sidewall construct 8 to form the container 105. In this regard, the sidewall 108 can be produced as a structure that receives the bottom 113 so that the bottom 113 can be selectively coupled at different locations of the sidewall 8 to provide an interior space of the container 105 with a different selected interior volume. Such features are described in U.S. Provisional Patent Application No. 62/674,834, filed on May 22, 2018, the entire contents of which are incorporated by reference herein With additional reference to FIGS. 7A, 7B, 7C, the angle α of the sidewall construct 8 can be selected such that the lower edge 27, 127 of a respective upper container 5, 105 engages the respective bottom panel 14, 114 of a respective lower receiving container 5, 105 prior to substantial frictional engagement of the sidewall constructs 8 of the respective containers 5, 105 e.g., so that respective containers 5, 105 can be easily separated or otherwise de-nested from one another. As shown in the nested arrangement of FIG. 7C, the lower edge 127 of the upper container 105 is in contact with the bottom panel 114 of the lower container while an air gap G1 is maintained between the outer sleeve 123 of the inner container and the inner sidewall 19 of the lower container. The presence of the air gap G1 in the nested configuration prevents taper locking of the upper and lower containers 105 and allows easy separation of the upper and lower containers 105 from the nested configuration of FIGS. 7B and 7C. In one embodiment, the container 5 can include surface features to facilitate separation or de-nesting, for example, embossed and/or embossed surfaces. Such an arrangement of the containers 5, 105 can provide significant space savings for transport and/or storage of the containers 5, 105.

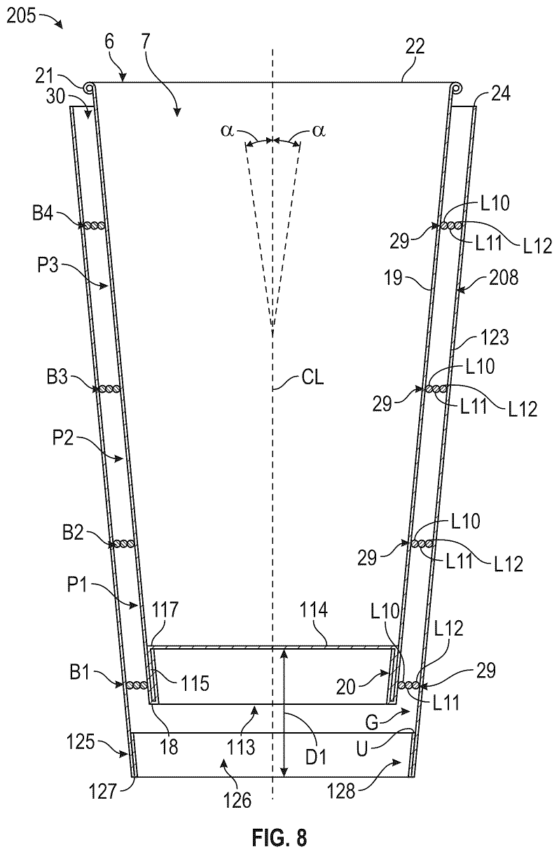

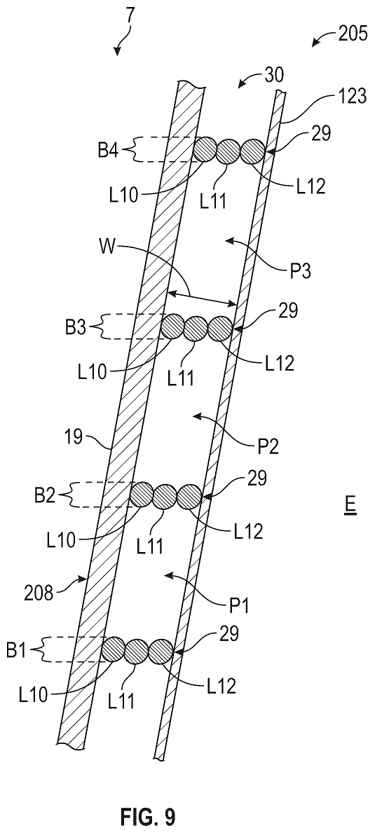

Referring additionally to FIGS. 8-10B, a container 205 is illustrated according to a third exemplary embodiment of the disclosure. It will be understood that the container 205 is similar to the container 105 of the second embodiment, except the container 205 includes a sidewall construct 208 with the bands B1, B2, B3, B4 of each spacer 29 between the inner sidewall 19 and the outer sleeve 123 comprising three layers of adhesive L10, L11, L12. One or more portions of the container 205 are substantially similar to that of the containers 5, 105 of the first and second exemplary embodiments of the disclosure, and like or similar reference numbers will refer to such like or similar elements.

In the embodiment of FIG. 8, the inner layer of adhesive L10 is in contact with the inner sidewall 19, the middle layer of adhesive L11 is adjacent and in contact with the inner layer of adhesive L10, and the outer layer of adhesive L12 is adjacent and in contact with the middle layer of adhesive L11 and the outer sleeve 123. The combined width of the three layers of adhesive L10, L11, L12 from the inner sidewall 19 to the outer sleeve 123 comprises the spacing or width W of the pockets P1, P2, P3 of the insulating features of the container 205. The insulating features and the container 205 could be otherwise shaped, arranged, and/or configured without departing from the disclosure.

The container 205 has a closed bottom 113 similar to the container 105 of the second embodiment. As with the second embodiment, the outer sleeve 123 extends downwardly past the lower edge 18 of the inner sidewall 19 to form an annular base 125 of the container 105 such that a lower portion of the outer sleeve 123 defines an interior annular recess 126 between the lower edge 127 of the annular base 125/container 105 and a bottom panel 114. A lower edge margin 128 of the sleeve 123, as shown, is interiorly folded into the annular recess 125 into face-to-face contact with a lower portion of the outer sleeve 123/annular base 125 to define the lower edge 127 and to provide a two-ply structure at a bottom portion of the annular base 125 upon which the container 105 can rest in an upright orientation. As also shown, the closed bottom 113, including the bottom panel 114 and an annular leg 115 foldably connected thereto at a line of weakening 117, are positioned a vertical distance above the lower edge 127 of the container 205, and an annular discontinuity or annular gap G is defined between the lower edge 18 of the inner sidewall 19 and an upper edge U of the lower edge margin 128 of the sleeve 123. In one embodiment, the annular gap G can provide a vent for one or more portions of the cavity 30. The closed bottom 113 could be otherwise shaped, arranged, and/or configured without departing from the disclosure.

In one embodiment, the inner sidewall 19 and the sleeve 223, with insulating features therebetween, can be separately formed from the closed bottom 113, and so that the bottom 113 can be coupled to the sidewall construct 208 to form the container 205. In this regard, the sidewall construct 208 can be produced as a structure that receives the bottom 113 so that the bottom 113 can be selectively coupled at different locations of the sidewall 8 to provide an interior space of the container 205 with a different selected interior volume. Such features are described in U.S. Provisional Patent Application No. 62/674,834, filed on May 22, 2018, and U.S. patent application Ser. No. 16/382,265 filed Apr. 12, 2019, the entire contents of which are incorporated by reference herein.

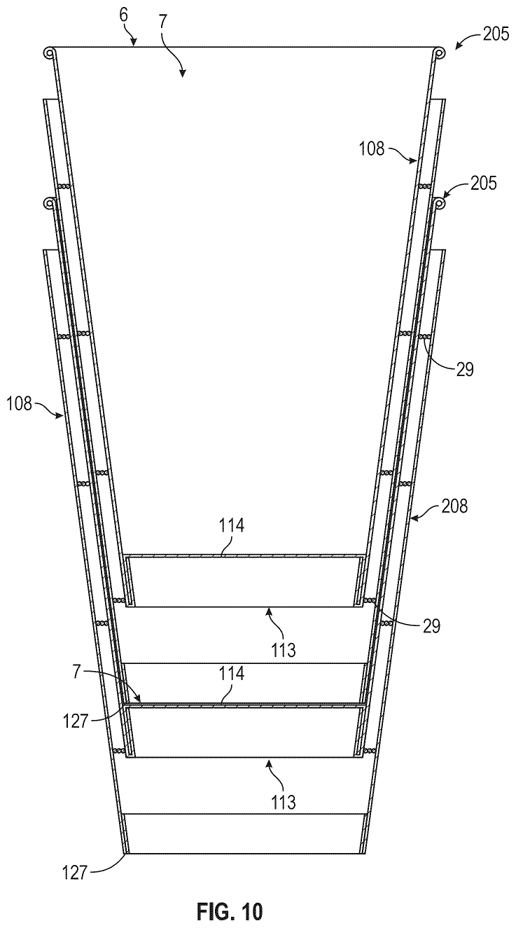

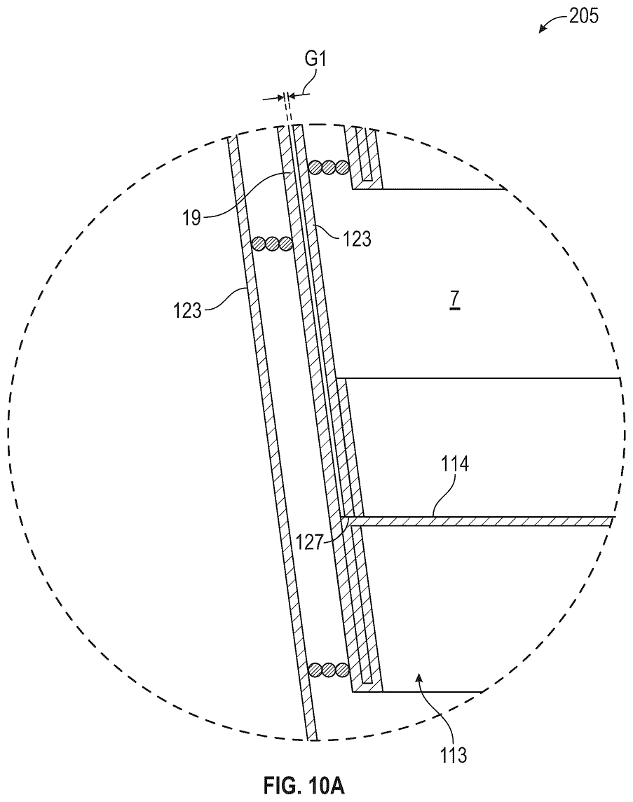

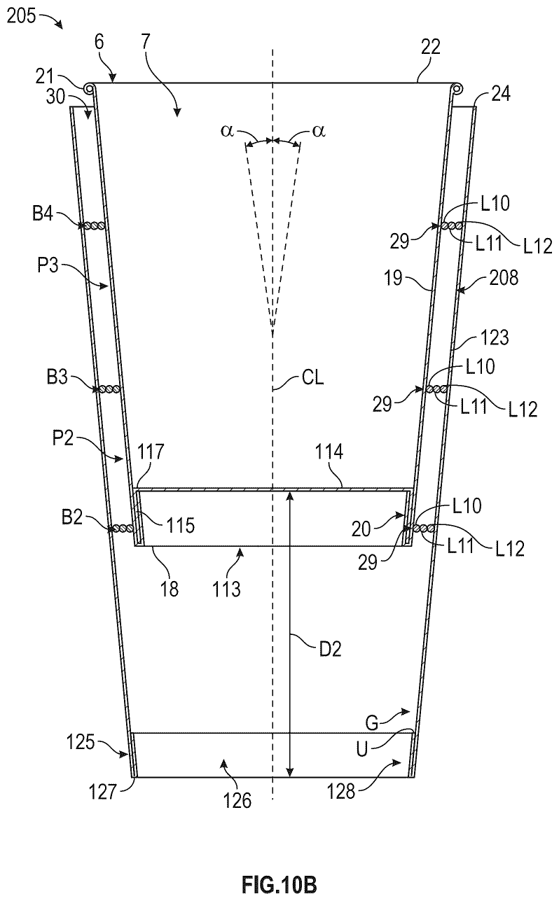

As shown in FIG. 8, the container 205 is shown with the bottom panel 114 of the closed bottom 113 positioned at a distance D1 from the lower edge 127 of the container. As shown in FIG. 10B, the container is illustrated with the bottom panel 114 of the closed bottom 113 in a raised positioned relative to FIG. 8, so that the bottom panel 114 is positioned at a distance D2 from the lower edge 127 of the container. In embodiment, D1 and D2 can be at least about ⅝ inch, or D1 and D2 can be in the range of at least about ⅝ inch to about 1.25 inches without departing from the disclosure. It will be understood that the closed bottom 113 can be positioned at any desired vertical location of the sidewall construct 208 having a constant angle α to provide an interior volume corresponding to a desired fluid size for the container 205. In this regard, at least the configuration and/or location of the bottom 113 of containers formed from the sidewall construct 208 allows for the interior volume of the containers to be selected by a user so as to provide the sidewall construct 208 and containers formed therefrom with scalable features.

As with the previous embodiments, the container 205 has features that allow for “bottom nesting”. As shown in FIGS. 10 and 10A, the angle α of the sidewall construct 208 can be selected such that the lower edge 127 of a respective upper container 205 engages the respective bottom panel 114 of a respective lower receiving container 205 prior to substantial frictional engagement of the sidewall constructs 208 of the respective containers 205, so that respective containers 205 can be easily separated or otherwise de-nested from one another. As shown in the nested arrangement of FIGS. 10 and 10A, the lower edge 127 of the upper container 205 is in contact with the bottom panel 114 of the lower container while an air gap G1 is maintained between the outer sleeve 123 of the inner container and the inner sidewall 19 of the lower container. The presence of the air gap G1 in the nested configuration prevents taper locking of the upper and lower containers 205 and allows easy separation of the upper and lower containers 205 from the nested configuration of FIGS. 10 and 10A. In one embodiment, the container 205 can include surface features to facilitate separation or de-nesting, for example, embossed and/or embossed surfaces. Such an arrangement of the containers 205 can provide significant space savings for transport and/or storage of the containers 205. In one embodiment, the angle α can be approximately 7.3 degrees, or the angle α could be in the range of about 2 degrees to about 10 degrees.

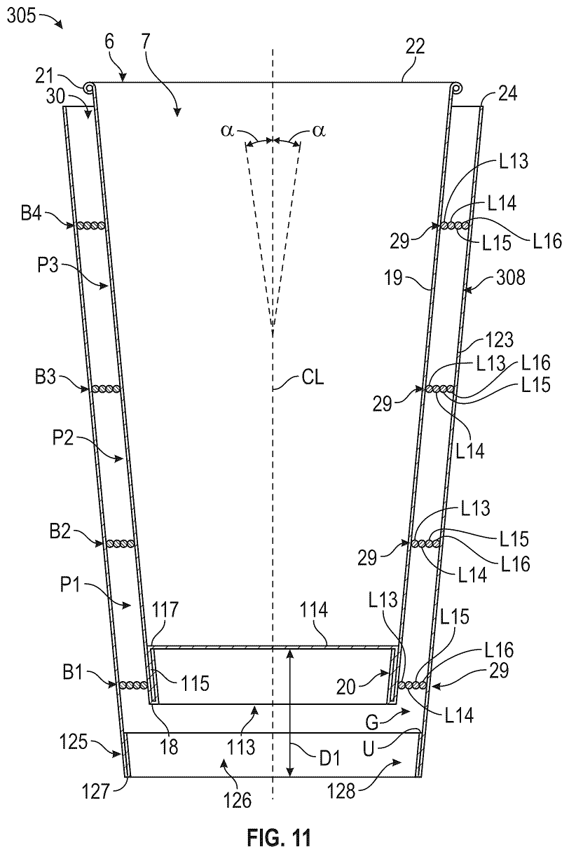

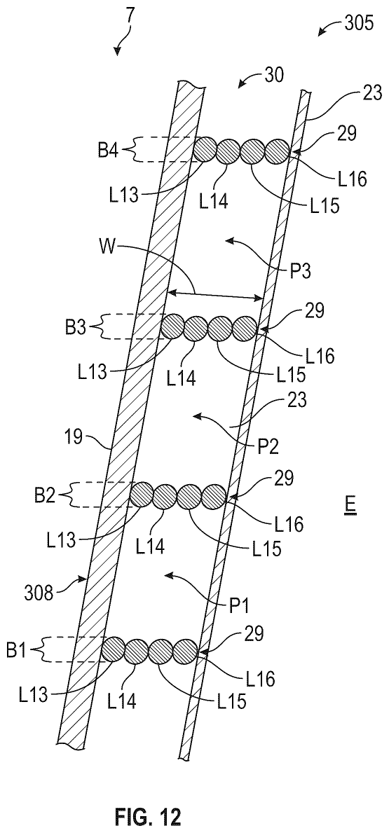

Referring additionally to FIGS. 11-13B, a container 305 is illustrated according to a fourth exemplary embodiment of the disclosure. It will be understood that the container 305 is similar to the container 205 of the third embodiment, except the container 305 includes a sidewall construct 308 with the bands B1, B2, B3, B4 of each spacer 29 between the inner sidewall 19 and the outer sleeve 123 comprising four layers of adhesive L13, L14, L15, L16. One or more portions of the container 305 are substantially similar to that of the containers 5, 105, 205 of the first, second, and third exemplary embodiments of the disclosure, and like or similar reference numbers will refer to such like or similar elements.

In the embodiment of FIG. 11, the inner layer of adhesive L13 is in contact with the inner sidewall 19, the first middle layer of adhesive L14 is adjacent and in contact with the inner layer of adhesive L13, the second middle layer L15 of adhesive is adjacent and in contact with the first middle layer of adhesive L14, and the outer layer of adhesive L16 is adjacent and in contact with the second middle layer of adhesive L15 and the outer sleeve 123. The combined width of the four layers of adhesive L13, L14, L15, L16 from the inner sidewall 19 to the outer sleeve 123 comprises the spacing or width W of the pockets P1, P2, P3 of the insulating features of the container 305. The insulating features and the container 305 could be otherwise shaped, arranged, and/or configured without departing from the disclosure.

The container 305 includes a similar closed bottom 113 as the container 205 in that the container 305 is also scalable with the bottom panel 113 positionable at various distances D1, D2 from the lower edge 127 of the container 305. The container 305 could have other bottom features without departing from the disclosure.

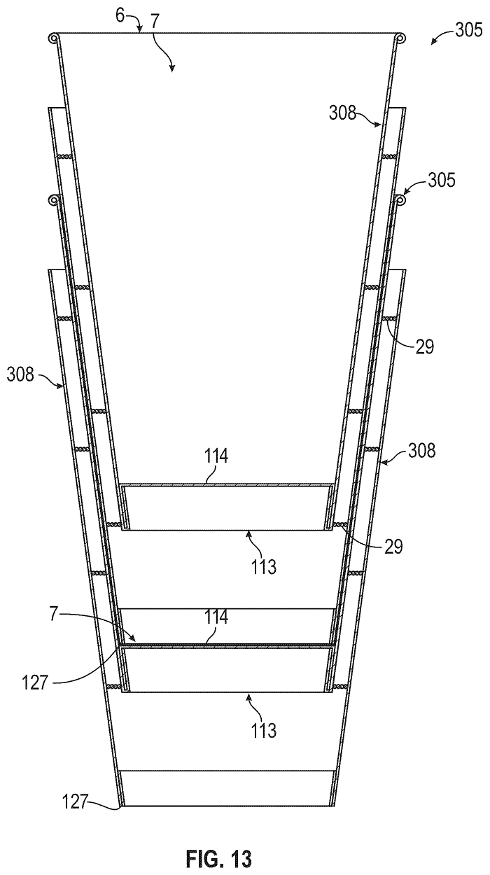

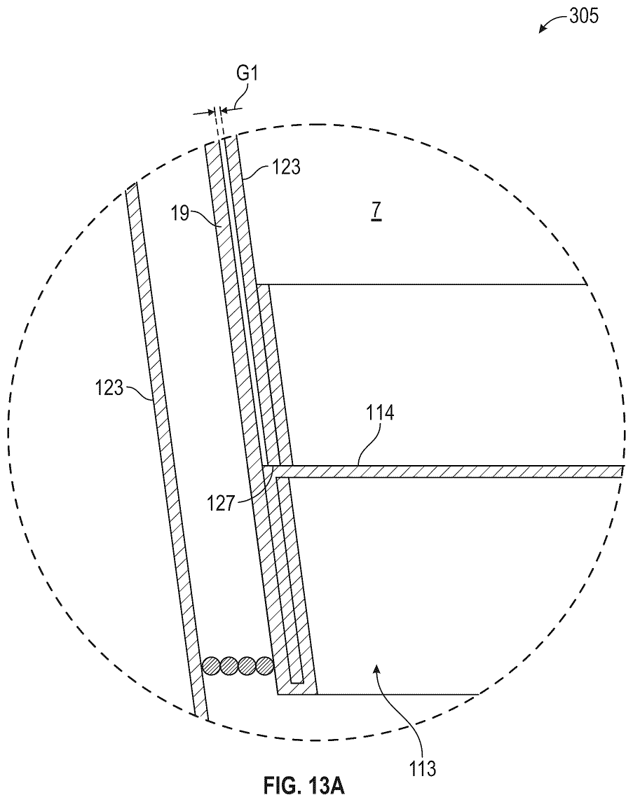

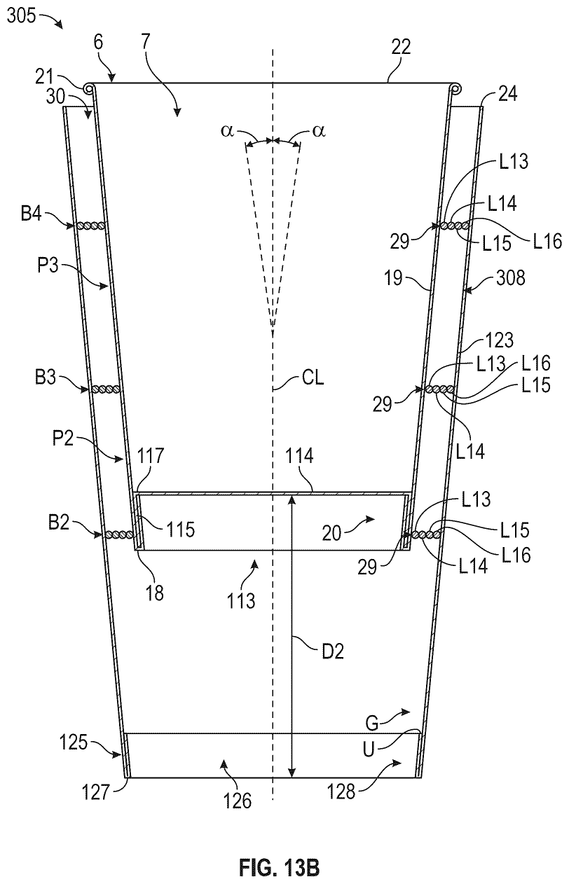

As shown in FIG. 13, and 13A, the container 305 has features that allow for “bottom nesting” in a similar manner as the containers 105, 205, with the angle α of the sidewall construct 308 being selected such that the lower edge 127 of a respective upper container 305 engages the respective bottom panel 114 of a respective lower receiving container 305 prior to substantial frictional engagement of the sidewall constructs 308 of the respective containers 305, so that respective containers 305 can be easily separated or otherwise de-nested from one another. As shown in the nested arrangement of FIGS. 13 and 13A, the lower edge 127 of the upper container 305 is in contact with the bottom panel 114 of the lower container while an air gap G1 is maintained between the outer sleeve 123 of the inner container and the inner sidewall 19 of the lower container. The presence of the air gap G1 in the nested configuration prevents taper locking of the upper and lower containers 305 and allows easy separation of the upper and lower containers 305 from the nested configuration of FIGS. 13 and 13A. In one embodiment, the container 305 can include surface features to facilitate separation or de-nesting, for example, embossed and/or embossed surfaces. Such an arrangement of the containers 305 can provide significant space savings for transport and/or storage of the containers 305. In one embodiment, the angle α can be approximately 7.3 degrees, or the angle α could be in the range of about 2 degrees to 10 degrees.

The containers 5, 105, 205, 305 can have various dimensions and features that allow for enhanced insulating features as well as bottom nesting of the closed bottom in a stacked arrangement of the containers (FIGS. 7A, 7B, 7C, 10, 10A, 13, 13A). For example, the insulating features such as the pockets P1, P2, P3, P4 can have a width W in the range of between about 60 mils and about 120 mils, for example, about 60 mils, about 70 mils, about 80 mils, about 90 mils, about 100 mils, about 110 mils, about 120 mils, etc. or integer or non-integer numbers therebetween. In one embodiment, the width W can be about 80 mils. In one embodiment, the angle α can be in the range of about 2 degrees to about 10 degrees, for example about 7 degrees, about 7.3 degrees, or any angle therebetween. The bottom panel 114 of the closed bottom 113 can be spaced from the lower edge 127 of the container a distance D1, D2 in the range of about 0.625 inches to about 1.25 inches. In one embodiment, the distance D1, D2 is approximately 0.9 inches. The containers 5, 105, 205, 305 can have other dimensions than listed herein, as the dimensions herein are exemplary of suitable embodiments of containers having insulating features and bottom nesting features.

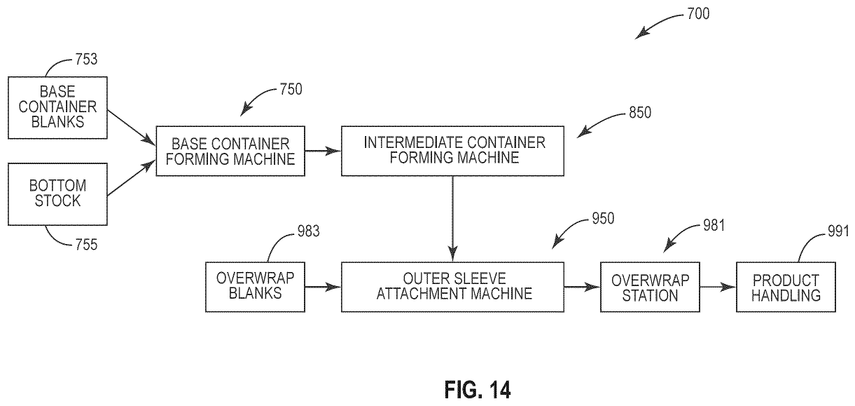

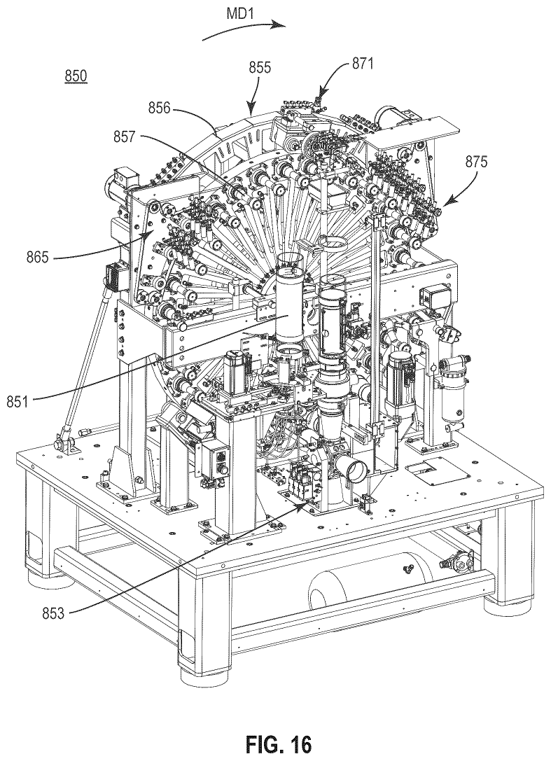

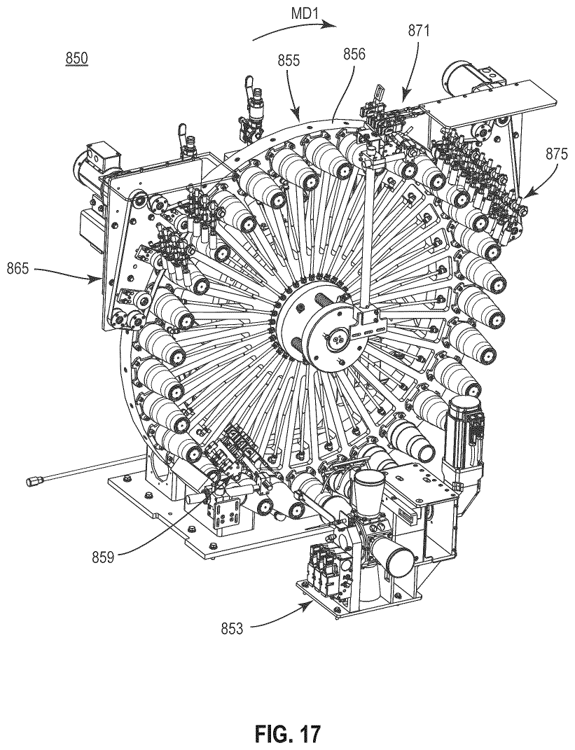

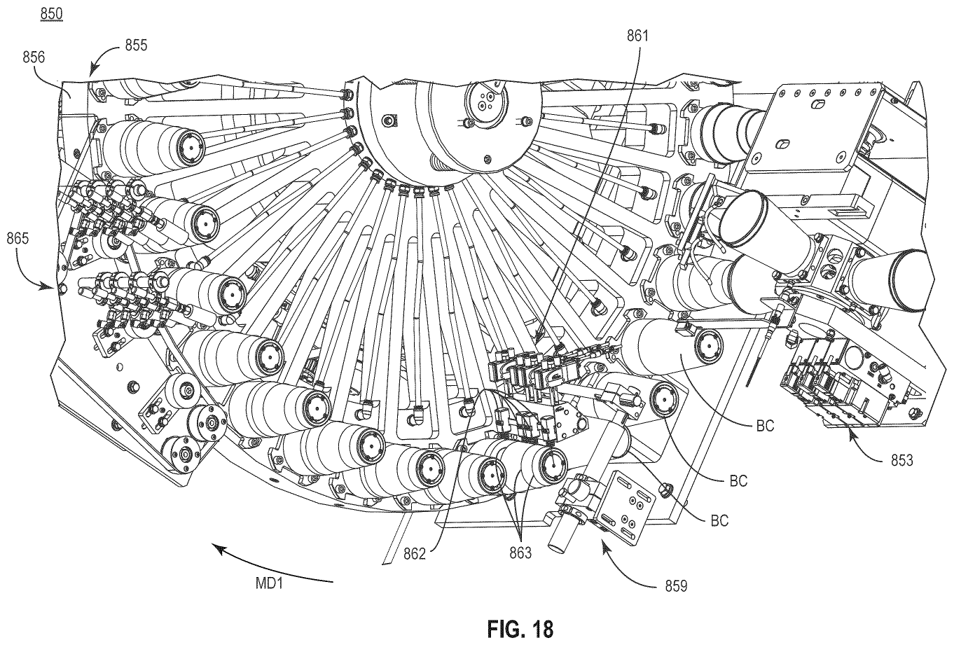

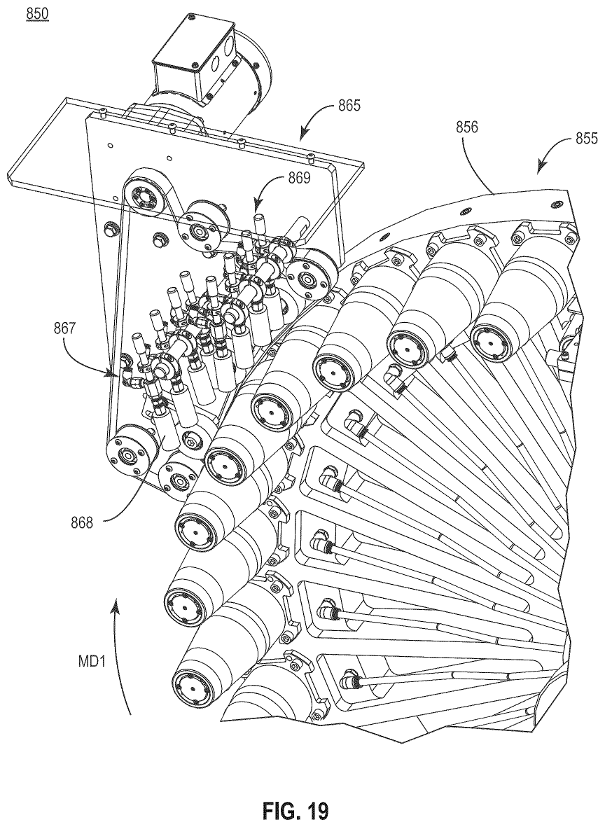

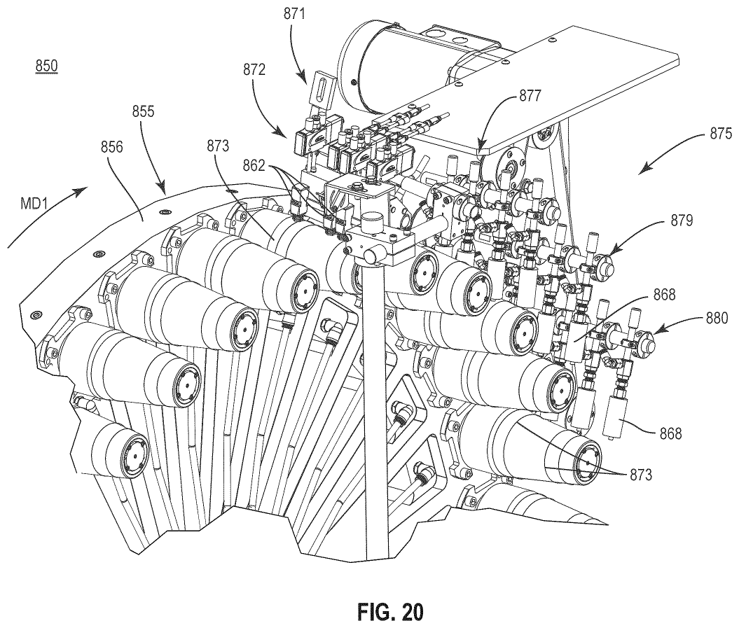

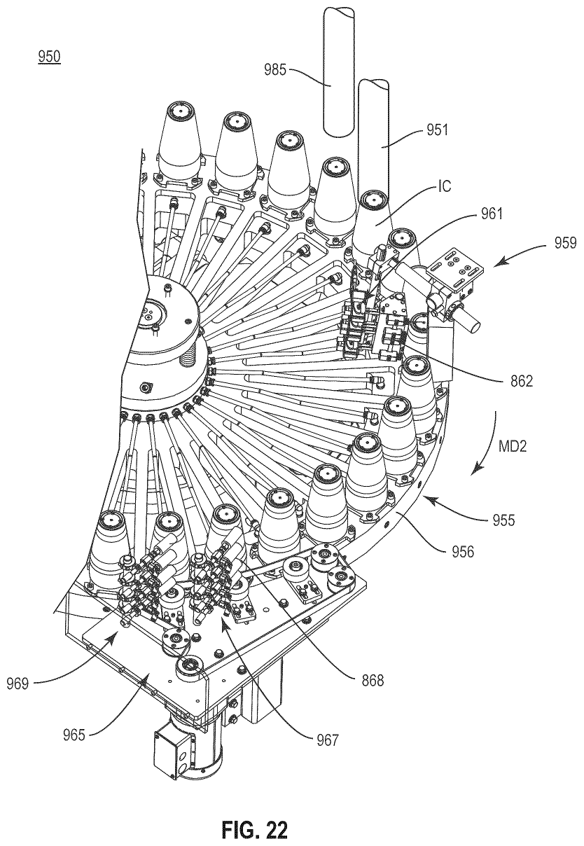

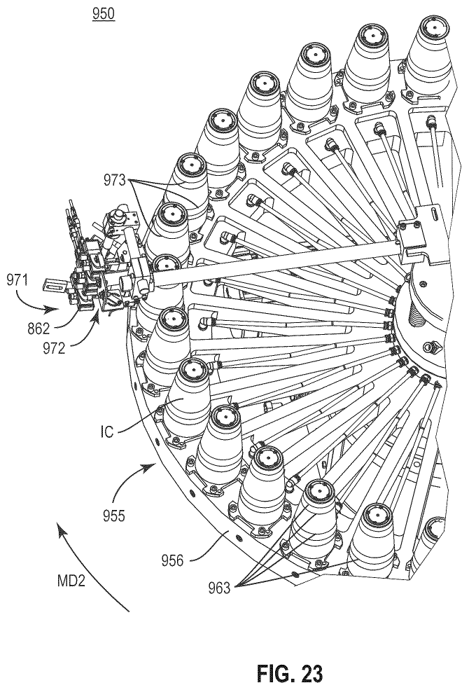

FIGS. 14-23 illustrate various systems, processes, methods, machines, apparatus, components, and forming machines for forming any of the containers 5, 105, 205, 305 of the present disclosure.

FIG. 14 shows a schematic flow diagram of a system 700 for forming various containers 5, 105, 205, 305 for containing a fluid of the present disclosure. The system 700 includes a base container forming machine 750 for forming a base container BC including the inner sidewall 19 and the closed bottom 13, 113 secured to the inner sidewall 19 to define the interior volume of the container 5, 105, 205, 305, an intermediate forming machine 850 that receives the base container BC from the base container forming machine and forms an intermediate container IC at least partially forming the glue beads that form the spacers 29 onto the base container BC, and an outer sleeve attachment machine 950 for receiving the intermediate container IC and attaching the outer sleeve 23, 123 to the intermediate container IC to complete the formation of the containers 5, 105, 205, 305. The system could include other machines, processes, components, etc., or the machines, processes, components, etc. shown and described herein could be modified or omitted without departing from the disclosure.

In some embodiments, one or more controllers can be provided in electrical communication with the system 700, e.g., via a wired and/or wireless electrical connection. Such controller can include a processor configured to implement one or more instructions stored on a non-transitory storage medium, and can be configured for operator input and/or manual control. In this regard, a controller can be or can form a part of a software program running on a computer, a programmable logic controller (PLC), another processor-implemented controller, or other control feature as will be understood by those skilled in the art. Such controller(s) can implement one or more processes of the system 700 and constituent machine(s) as described herein.

In one embodiment, the base container forming machine 750 can form base container blanks 753 into the inner sidewall 19 and form bottom stock 755 into the closed bottom 13, 113 of the base container BC. The base container forming machine 750 transmits the base containers BC to the intermediate container forming machine 850. The base container forming machine 750 can be a conventional container or cup forming machine such as the machines available from Paper Machinery Corporation of Milwaukee, Wisconsin, or other suitable container or cup forming machines without departing from the disclosure. For example, the base container forming machine 750 can be similar to the exemplary cup making machine or apparatus 10 described in U.S. Pat. No. 10,835,066, the entire disclosure of which is incorporated by reference herein as if presented herein in its entirety.

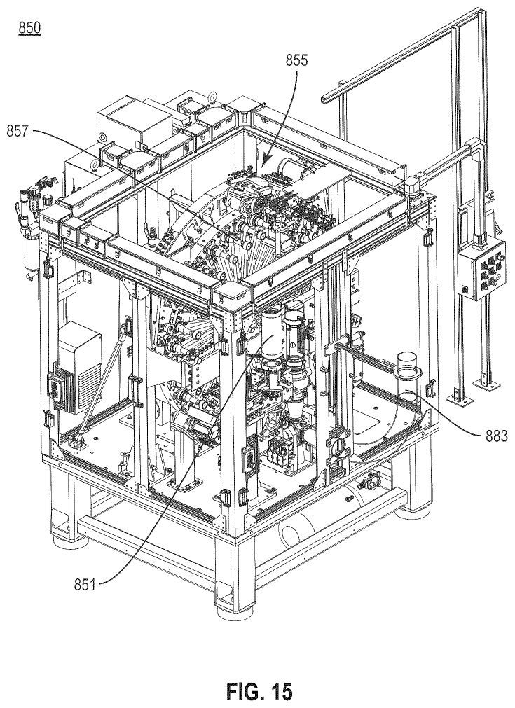

FIGS. 15-20 show various views and details of the intermediate container forming machine 850 according to an exemplary embodiment. In one embodiment, the intermediate container forming machine 850 includes a conveyor tube 851 that receives the base containers BC from the base container forming machine 750.

The intermediate container forming machine 850 can include a machine frame supporting the various assemblies and components thereof described herein. The machine frame can include one or more of bases, legs, struts, tie bars, platforms, etc., in various arrangements, to provide a supporting structure for the assemblies and components described herein. For example, the machine frame can support such components above a base surface such as a ground or floor, and can provide access at one or more locations for human operators, to inspect, maintain, and/or otherwise operate the machine 850, e.g., control stations, panels, terminals, etc.

The intermediate container forming machine 850 includes a turret assembly 855 that is rotatably mounted in the machine and which has a turret body 856 supporting a plurality of mandrels 857 protruding therefrom for receiving a respective base container BC from the conveyor tube 851. In some embodiments, one or more of the mandrels 857 can have a rod-like configuration. In some embodiments, one or more of the mandrels 857 can have a frustoconical configuration that approximates an interior volume of a respective container 5, 105, 205, 305.

As described herein, the turret assembly 855 can rotate in a machine direction MD1 (clockwise in the view of FIGS. 15-20) to move the base containers BC mounted on a respective mandrel 857 through various forming stations in the intermediate container forming machine 850. Furthermore, the respective mandrels 857 can be rotatably mounted about the turret body 856 so as to be rotatable relative thereto. In some embodiments, one or more of the mandrels 857 can be rotatably fixed to the turret body 856.

In this regard, the turret assembly 855 can be in mechanical communication with one or more actuators and/or actuating mechanisms, e.g., motors, pneumatic actuators, hydraulic actuators, etc., that can be either directly coupled to one or more portions of the turret assembly 855 or via one or more mechanical transmissions. Such actuators and/or actuating mechanisms can independently or collectively drive the turret body 856 and mandrels 857 to rotate in the manner described herein. In some embodiments, one or more rotational driving members, e.g., belts, pulleys, etc., can be driven and positioned for contact with one or more base containers BC positioned about a respective mandrel 857 to cause rotation thereof.

In one embodiment, the intermediate container forming machine 850 includes a first material application station or first adhesive application station 859 that includes a first material applicator or first adhesive applicator 861 that applies the first layer of glue beads 863 that form the spacers 29 of the finished container 5, 105, 205, 305. The first adhesive applicator 861 can include a plurality of spaced apart adhesive applicator members 862 that can be configured to selectively eject adhesive such as glue therefrom. In some embodiments, the adhesive applicator members 862 can define interior channels through which at least partially heated or melted glue can flow, for example, under the influence of gravity and/or under pressure from a pressure sources such as an actuator. The glue can exit the respective adhesive applicator members 862 through an opening, nozzle, etc. While the first adhesive applicator 861 illustrates a set of four spaced apart adhesive applicator members 862, it will be understood that a different number and/or arrangement of adhesive applicator members 862 can be provided without departing from the disclosure.

As glue is discharged from the respective adhesive applicator members 862 of the first adhesive applicator 861, the respective mandrel 857 at least partially received in the respective base container BC can be driven to rotate so that each glue bead 863 is applied 360 degrees around the base container BC. In some embodiments, the respective base container BC can be driven to rotate about the respective mandrel 857.

After the first glue beads 863 are applied, the turret body 856 can be driven to rotate to move the respective base container BC to a first cooling station 865 that applies air to the first layer of glue beads 863 to cool the beads 863. The first cooling station 865 includes a first air applicator 867 and second air applicator 869 that applies compressed air to the first glue bead 863 as the base container BC is rotated. Each air applicator 867, 869 can include a plurality of air applicator members 868 that can define a fluid path in communication with an air source of other fluid source, e.g., a blower or other pressurized fluid source.

In some embodiments, air or other fluids associated with one or more of the air applicator members 868 can be provided in fluid communication with one or more heating and/or cooling units so as to provide air or other fluids through the respective air applicator members 868 at a desired temperature. In some embodiments, one or more of the air applicator members 868 can include a respective nozzle, opening, or port for directing exiting air or other fluids toward the respective glue beads 863.

In some embodiments, the first glue beads 863 can be aged and cooled for between approximately 0.2 seconds and approximately 12 seconds, but this time may vary outside of this range without departing from the disclosure. Such aging and cooling of the glue beads 863 can include one or both of drying and curing of the adhesive that forms the glue beads 863. While the first air applicator 867 and the second air applicator 869 each illustrate a set of four spaced apart air applicator members 868, it will be understood that a different number and/or arrangement of air applicator members 868 can be provided without departing from the disclosure.

Next the turret body 856 can be driven to rotate so as to index a respective base container BC to a second material application station or second adhesive application station 871. The second adhesive application station 871 includes a second material applicator or second adhesive applicator 872 that applies the second layer of glue beads 873 that form the spacers 29 of the various containers 5, 105, 205, 305. The second adhesive applicator 872 can have the same general configuration of the first adhesive applicator 861 described above, e.g., so as to have the configuration and arrangement of adhesive applicator members 862 described above.

As described above with the first adhesive applicator 861, the respective mandrel 857 can be driven to rotate the base container BC disposed thereabout so that the second adhesive applicator 871 applies the second layer of glue beads 873 in a 360-degree pattern around the base container BC. In the illustrated embodiment, the second layer of glue beads 873 are applied on top of the first layer of glue beads 863 after the first layer of glue beads 863 has been aged and cooled.

After the second glue beads 873 are applied, the turret body 856 can again be driven to rotate to move the respective base container BC to a second cooling station 875 that applies air to the second layer of glue beads 873 to cool the beads. In one embodiment, the second cooling station 875 includes a first air applicator 877, a second air applicator 879, and a third air applicator 880 that applies compressed air to the second glue bead 873 as the mandrel 857 about which the respective base container BC is disposed is driven to rotate.

The first air applicator 877 and the second air applicator 879 of the second cooling station 875 can have a configuration similar to that of the first air applicator 867 and second air applicator 869 of the first cooling station 865, e.g., so as to include the configuration and arrangement of air applicator members 868 described above. Furthermore, the third air applicator 880 of the second cooling station 875 can have a configuration similar to that of the air applicators 867, 869, 877, 879.

In one embodiment, the second glue beads 873 are aged and cooled for between approximately 0.2 seconds and approximately 12 seconds, but this time may vary outside of this range without departing from the disclosure. After the second glue beads 873 have been aged and cooled, the base container BC is transformed into the intermediate container IC that is conveyed to the outer sleeve attachment machine 950 for further processing and forming into the formed containers 5, 105, 205, 305.

In the illustrated embodiment, the turret body 856 is further driven to rotate so as to index the respective intermediate container IC to a discharge station 881 that includes a cup positioning apparatus 853 that is configured to selectively orient intermediate containers IC received from a respective mandrel 857 to exit the intermediate container forming machine 850. In this regard, the cup positioning apparatus 853 can include at least an inlet port positioned adjacent the turret assembly 855, and a discharge port in communication with a discharge tube 883, as described further below. In some embodiments, the cup positioning apparatus 853 can include one or more actuators in mechanical communication with a respective engagement feature for grasping and moving, e.g., via tilting, turning, rotating, translating, etc., a respective intermediate container IC.

The discharge tube 883 can be configured to discharge the intermediate containers IC (the base containers BC with the first and second glue beads 863, 873 applied) from the turret assembly 855 to the outer sleeve attachment machine 950, for example, under a hydraulic or pneumatic pressure source, or other actuating mechanism.

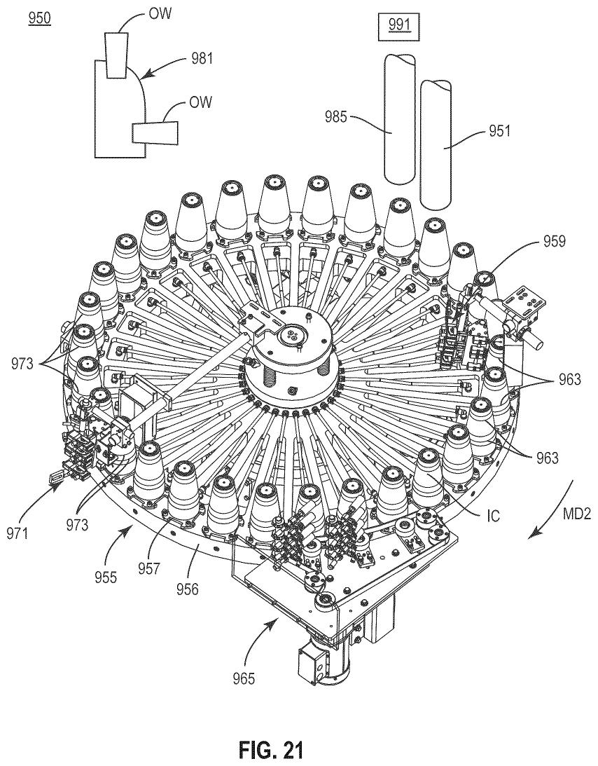

With additional reference to FIGS. 21-23, the outer sleeve attachment machine 950 can include an inlet station 951 that receives the intermediate containers IC that are conveyed from the discharge station 881/discharge tube 883 of the intermediate container forming machine 850. Such inlet station 951, in some embodiments, can include an inlet tube. It will be understood that the outer sleeve attachment machine 950 can include any number of frames, supports, platforms, etc.

The turret assembly 955 of the outer sleeve attachment machine 950 can have a configuration similar to that of the turret assembly 855 of the intermediate container forming machine 850 described above, e.g., so as to include a turret body 956 that is rotatably mounted in the outer sleeve attachment machine and which has a plurality of mandrels 957 rotatably mounted thereto and protruding therefrom for receiving a respective intermediate container IC from the inlet station 951.

However, in the illustrated embodiment, the turret assembly 955 of the outer sleeve attachment machine 950 can be oriented differently than that of the turret assembly 855 of the intermediate container forming machine 850 described above. For example, the turret body 956 of the turret assembly 955 of the outer sleeve attachment machine 950 can be rotatably mounted along a plane that is generally perpendicular relative to a plane defined by the turret body 856 of the turret assembly 855 of the intermediate container forming machine 850 as described above. In some embodiments, the turret body 956 of the outer sleeve attachment machine 950 can have a generally circular arrangement with a diameter smaller than that of the turret body 856 of the turret assembly 855 of the intermediate container forming machine 850 described above, though the turret bodies 856, 956 can be similar without departing from the disclosure.

As with the turret assembly 855 of the intermediate container forming machine 850, the turret assembly 955 of the outer sleeve attachment machine 950 can be in mechanical communication with one or more actuators and/or actuating mechanisms, e.g., motors, pneumatic actuators, hydraulic actuators, etc., that can be either directly coupled to one or more portions of the turret assembly 955 or via one or more mechanical transmissions. Such actuators and/or actuating mechanisms can independently or collectively drive the turret body 956 and mandrels 957 to rotate in the manner described herein. In some embodiments, one or more rotational driving members, e.g., belts, pulleys, etc., can be driven and positioned for contact with one or more intermediate containers IC positioned about a respective mandrel 957 to cause rotation thereof.

The turret assembly 955 can be driven to rotate in a machine direction MD2 (clockwise in the view of FIGS. 21-23) to move the intermediate containers IC mounted on a respective mandrel 957 through various forming stations in the outer sleeve attachment machine 950.

In one embodiment, the outer sleeve attachment machine 950 includes a third material application station or third adhesive application station 959 that includes a third material applicator or third adhesive applicator 961 that applies a third layer of glue beads 963 that form the spacers 29 of the finished container 205, 305. The third adhesive applicator 961 can have the same general configuration as the first adhesive applicators 861, 871 described above, e.g., so as to have the configuration and arrangement of adhesive applicator members 862 described above.

As glue is discharged from the third adhesive applicator 961, the respective mandrel 957 is driven to rotate such that the respective intermediate container IC disposed thereabout is rotated so that each glue bead 963 is applied 360 degrees around the intermediate container IC. The third glue beads 963 are applied on the surface of the second glue beads 873.

After the third glue beads 963 are applied, the turret body 956 can be driven to rotate to move the respective intermediate container IC to a third cooling station 965 that applies air to the third layer of glue beads 963 to cool the beads 963. In one embodiment, the third cooling station 965 includes a first air applicator 967 and second air applicator 969 that applies compressed air to the third glue beads 963 as the mandrel 957 about which the respective intermediate container IC is disposed is driven to rotate.

The first air applicator 967 and the second air applicator 969 of the third cooling station 965 can have a configuration similar to that of the first air applicators 867, 877 and second air applicators 869, 879 of the intermediate container forming machine 850 described above, e.g., so as to include the configuration and arrangement of air applicator members 868 described above.

In one embodiment, the third glue beads 963 are aged and cooled for between approximately 0.2 seconds and approximately 12 seconds, but this time may vary outside of this range without departing from the disclosure.

Next, the turret body 956 can be driven to further rotate so as to index the respective intermediate container IC to a fourth material application station 971 or fourth adhesive application station 971. The fourth adhesive application station 971 can include a fourth material applicator or fourth adhesive applicator 972 that applies the fourth layer of glue beads 973 that form the spacers 29 of the containers 305. The fourth adhesive applicator 972 can have the same general configuration of the adhesive applicators 861, 871, 961 described above, e.g., so as to have the configuration and arrangement of adhesive applicator members 862 described above.

As with the third adhesive applicator 961, the mandrel 957 about which the respective intermediate container IC is disposed can be driven to rotate so that the fourth adhesive applicator 972 applies the fourth layer of glue beads 973 in a 360-degree pattern around the respective intermediate container IC. In the illustrated embodiment, the fourth layer of glue beads 973 are applied on top of the second layer of glue beads 963 after the third layer has been aged and cooled.

After the fourth glue beads 973 are applied, the turret assembly 955 rotates to move the respective intermediate container IC to an overwrap station 981 (FIG. 21) that applies an overwrap layer OW to the intermediate cup IC having the four layers of adhesive 863, 873, 963, 973 to form the finished containers 305 with the outer sleeve 23, 123 corresponding to the overwrap layer OW.

The overwrap station 981 can receive overwrap blanks 983 (FIG. 14) and form the overwrap layer OW by adhesively securing the overwrap blank 983 to the intermediate container IC having the four layers of adhesive 863, 873, 963, 973. The overwrap layer OW can be applied to the fourth layer of adhesive 973 after the fourth layer of adhesive has been aged between approximately 0.2 seconds and approximately 12 seconds, but this time may vary outside of this range without departing from the disclosure. Alternatively, the outer sleeve forming machine 950 could include a fourth cooling station without departing from the disclosure.

Further, the fourth adhesive application station 971 could be omitted from the outer sleeve forming machine 950 so that the finished container produced from the outer sleeve forming machine corresponds to the container 205 having spacers with three layers of adhesive 863, 873, 963 without departing from the disclosure.

In the illustrated embodiment, the turret body 956 can be driven to further rotate so as to index to a discharge station 985 that discharges the finished container 205, 305 to a product handling machine 991 that prepares the finished containers 205, 305 for shipment such as by stacking in appropriate quantities and packaging for shipment.

The system 700 could have other machines and process for forming the containers 5, 105, 205, 305 without departing from the disclosure. Further, the intermediate container forming machine 850 could be alternatively constructed. For example, the intermediate container forming machine 850 could have more or less than two adhesive application stations or more or less than two adhesive cooling stations without departing from the disclosure. Further, the outer sleeve attachment machine 950 could have more or less than two adhesive application stations or more or less than one adhesive cooling station without departing from the disclosure. Any of the features of the system 700 could be alternatively, shaped, arranged, configured, or omitted without departing from the disclosure.

Further disclosed are methods for forming insulating features of double-walled containers having a sidewall construct with an air gap therein. The insulating features can comprise a plurality of adhesive bead layers formed into a plurality of annular bands. The methods can include improved techniques for forming containers with an air gap of the desired width using the minimum amount of material (i.e., the amount of adhesive or glue bead material applied to form insulating features), For example, as successive glue or adhesive beads are layered to form the desired air gap between a nested inner substrate and an outer sleeve or overwrap, process variables can be modified such that taller glue bead layers are formed while maintaining the same or less applied glue mass. Variables include multiple adhesive bead materials, individual layer temperature control, adhesive dispensing angle, continuous cooling, dwell time, and/or other variables. Experience has shown that, for example, double-walled containers must have an air gap having a width (e.g., a width W of insulating features, such as the pockets P1, P2, P3, P4, in FIGS. 4, 9, and 12) of at least 0.080″ to replicate the insulating performance of conventional Styrofoam cups.

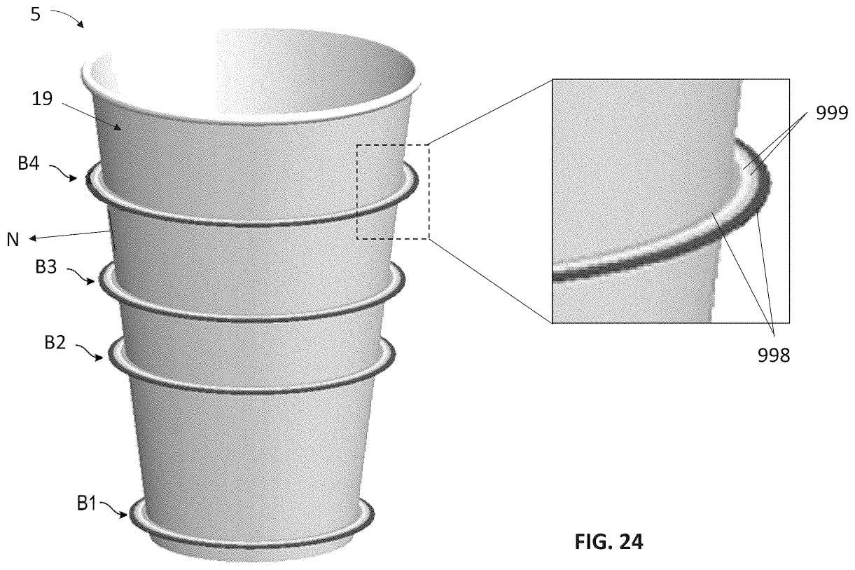

FIGS. 24-32 illustrate further methods for forming any of the containers 5, 105, 205, 305, 405, and 505 of the present disclosure and containers formed from the methods of the present disclosure.

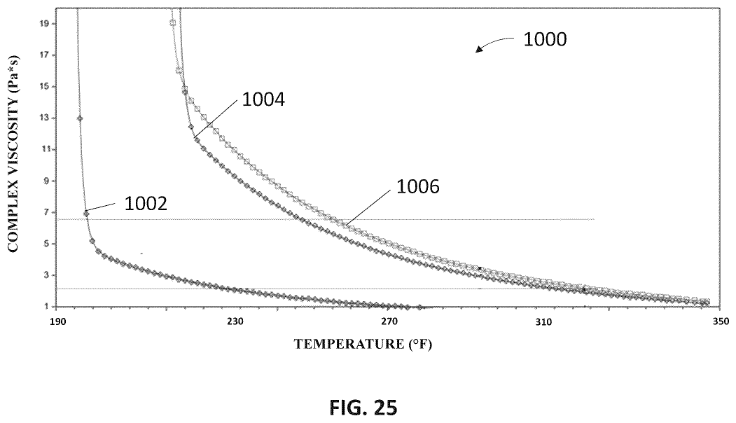

With reference to FIGS. 24 and 25, In some embodiments, the individual glue beads in bands B1, B2, B3, B4 layered at different locations on the inner sidewall 19 of the container 5 include outer layers 998 (a first layer and a final layer) and one or more inner or intermediate layers 999. The outer layers 998 and inner layers 999 can be formed from hotmelt adhesives. Hotmelt adhesives are composed of various components, including a base polymer, tackifiers, plasticizers, and/or other additives. The base polymer determines the primary characteristics of the hotmelt adhesive, such as flexibility, temperature resistance, and adhesion properties. For example, to optimize performance, hotmelt adhesives are formulated to have a specific viscosity range at their application temperature. This ensures that the hotmelt adhesive flows easily during application and wets a substrate properly, and maintains the necessary viscosity to form a strong bond upon cooling.

Adhesive dispensing systems (e.g., adhesive applicator 861 having adhesive applicator members 862 as described herein or adhesive applicators of any of the adhesive application stations 859, 871, 959, 971) can be used to control variables in the adhesive application process. For example, the type of adhesive, tank, hose, and manifold temperatures, tank pressures, and openings or nozzle sizes that influence the mass flow rate of the adhesive being dispensed, and optimizing these parameters can improve process efficiency by reducing dwell times. Although examples of container forming machines and adhesive applicators are disclosed herein, other systems and machines can be used without departing from the disclosure.

Hotmelt adhesives used in the construction of insulated containers are applied at certain temperatures to a substrate (e.g., the inner sidewall 19 or previously-applied adhesive layers) and forced to cool to a higher-viscosity state to form glue beads. The size and shape of the beads are dependent on the viscosity of the adhesive used and the application temperature. As temperature increases, the viscosity of the adhesive decreases, reducing resistance to flow and allowing the adhesive to wet the substrate efficiently. This inverse viscosity-temperature relationship is important for bonding with a substrate, as if the adhesive viscosity is too high at the application temperature, it may not spread evenly over the substrate, resulting in weak bonds. A lower-viscosity, higher temperature hotmelt adhesive (i.e., an adhesive with a higher application temperature) can penetrate the substrate more effectively, resulting in a stronger bond that is able to withstand service temperatures without compromising the integrity of the bond.

Conversely, as temperature decreases, the viscosity increases, causing the adhesive to thicken. However, applying a lower temperature hotmelt adhesive (i.e., an adhesive with a lower application temperature that is closer to the glass transition temperature of the material than the application temperature of a higher temperature adhesive) can be advantageous as the adhesive requires less dwell time and/or cooling to reach glass transition. For example, if the hotmelt material has a glass transition temperature between approximately 190-200° F. (87.8-93.3° C.), an application temperature of as low as 220° F./104.4° C. would require a short dwell time to tackify and form a taller glue bead for the same amount of adhesive used with a higher temperature hotmelt adhesive. For double walled structures such as those described herein, where forming a barrier with a certain air gap is a functionality requirement for the hotmelt adhesive material, the material viscosities of lower temperature hotmelt materials can form taller glue beads to build the air gap with a minimum of material used.

Experimental and simulated material analysis was conducted in order to determine the influence of various factors on the hotmelt adhesive bead height. The variable factors used included different operational conditions such as the type of hotmelt adhesive, hotmelt application temperature, the size of the opening or nozzle used to deliver the adhesive, the delivery discharge pressure of the adhesive, the angle of adhesive application relative to the substrate, and the cooling rate and dwell time used for individual layers. FIG. 25 shows rheological testing data 1000 for three different tested hotmelt materials, 1002, 1004, and 1006 (TECHNOMELT® Supra™ PRO 450™ Hot Melt [hereinafter Supra 450], TECHNOMELT® Supra™ 614C Hot Melt [Supra 614], and TECHNOMELT® Supra™ 128 Hot Melt [Supra 128], respectively). Lower application temperatures corresponded to higher viscosities of the hotmelt materials 1002, 1004, 1006, a reduced time to reach the material glass transition temperature, and less wetting of the surface of the substrate surface. Compared with higher temperature hotmelt materials, Supra 450 had a lower viscosity at application temperatures above glass transition, which can reduce material stringing (e.g., when adhesive remains on the nozzle and is pulled into strands). Testing results also indicated that when an adhesive needed to bond to a container substrate (i.e., coated paperboard and similar materials), a minimum application temperature of approximately 280° F./137.8° C. was required to attain sufficient bonding between the hotmelt materials and the substrate.

As seen in FIG. 25, a lower temperature hotmelt material 1002 (e.g., Supra 450 with an application temperature of approximately 220° F./104.4° C.) having a lower melting glass transition is capable of maintaining higher viscosities at lower temperatures, providing the benefit of taller glue beads for intermediate layers 999 (i.e., the “middle” layers, where effective adhesion between hotmelt material layers does not require higher temperatures). At least the first layer/inner layer 998 (adhesion to the base substrate) and final layer/outer layer 998 (adhesion to the overwrap or outer sleeve) of beads can require a higher temperature hotmelt material (e.g., an application temperature of approximately 280° F./137.8° C.). The higher temperature hotmelt materials 1004, 1006 (e.g., Supra 614, Supra 128, and/or another material) can be used to wet the surface and form sufficient bonding with the respective substrates. Thus, advantages were found in utilizing at least two different hotmelt materials; a higher temperature hotmelt material for the first and final/outer layers 998 to provide sufficient bonding, and a lower temperature hotmelt material for the intermediate/middle layers 999 to create taller glue beads to achieve the desired total air gap width with the least amount of adhesive. In some embodiments, the inner layer 998 comprising a higher temperature hotmelt adhesive can correspond to one or more of the inner layers L1, L3, L5, L7, L10, L13 of the earlier embodiments of the container 5, 205, 305; one or more of the intermediate layers 999 comprising a lower temperature hotmelt adhesive can correspond to the intermediate layers L11, L14, L15 of the earlier-described embodiments of the container 205, 305; and the outer layer 999 comprising a higher temperature hotmelt adhesive can correspond to outer layers L2, L4, L6, L8, L12, L16 of the earlier-described embodiments of the containers 5, 205, 305.

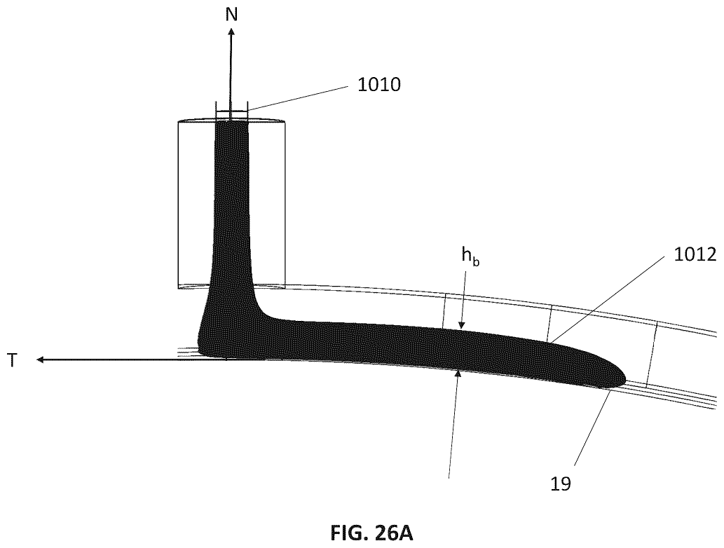

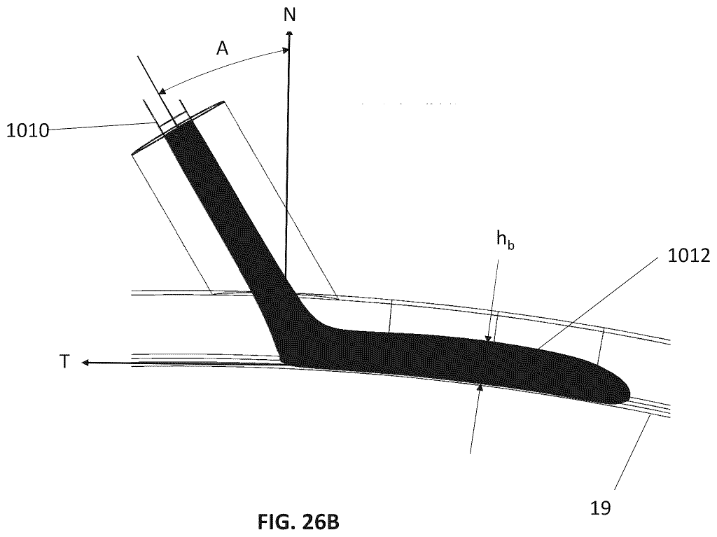

With reference to FIGS. 26A and 26B, in some embodiments, the glue beads of bands B1, B2, B3, B4 can be applied at an angle relative to the surface of the inner sidewall 19. Experiments and simulations demonstrated that an application angle or angle of incidence (i.e., an angle A relative to a direction N normal/perpendicular to the tangent T of an application surface) of hotmelt material application has an effect on the resulting adhesive bead height. For example, a hotmelt material can be heated and supplied (e.g., from adhesive applicator members 862 as described herein of adhesive applicator 861 or adhesive applicators of any of the adhesive application stations 859, 871, 959, 971 described herein, or any other applicable delivery mechanisms) to openings or nozzles 1010 oriented at angle A relative to direction N normal/perpendicular to the tangent T of the application surface (e.g., inner sidewall 19).

Simulations were performed to determine the influence of adhesive application angle A on resulting overall adhesive bead height. FIG. 26A shows a numerical modeling simulation of an embodiment where a nozzle 1010 positioned coincident with a direction N perpendicular to the tangent T of the surface arc of the inner sidewall 19 of the container 5. A layer of adhesive is applied from a nozzle 1010 to form a bead 1012 of adhesive having a height h_{b}. Similarly, FIG. 26B shows a simulation of an embodiment where the nozzle 1010 is positioned at an angle A offset from direction N perpendicular to the tangent T of the application surface arc, producing a bead 1012 having a height h_{b}. In some embodiments, angle A can be in a range from approximately 0 degrees to approximately 45 degrees but may vary outside of this range without departing from the disclosure. In some embodiments, angle A can be approximately 30 degrees.

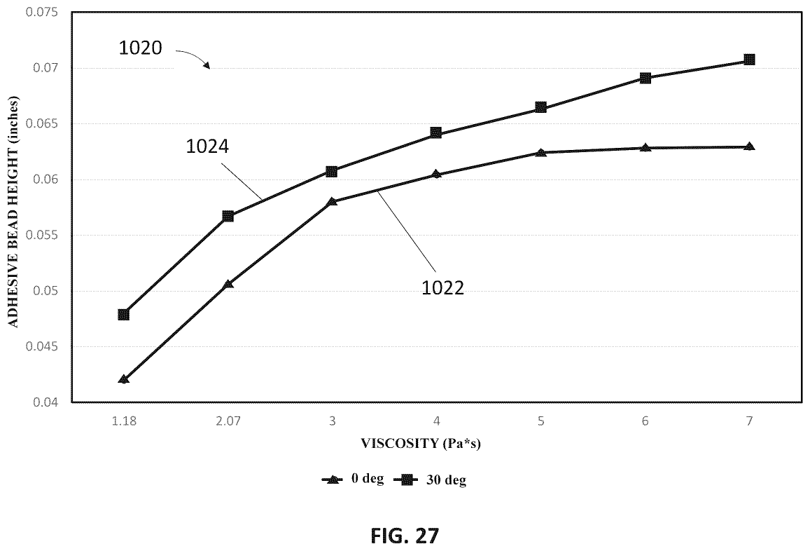

FIG. 27 shows a plot of simulation results 1020 comparing glue bead heights achieved for A=0 (1022) and A=30 (1024) over a range of adhesive material viscosities. Results indicated that when A=30, an increase in bead height h_{b} of between 4.8%-14.3% was observed over A=0 for the same quantity of adhesive used within the range of material viscosities tested. Simulation predictions showed that the angle A can increase the resulting adhesive bead height by approximately 12% for a hotmelt material having a viscosity of 2.07 Pa·s at application.

The methods of forming the insulating features for the disclosed containers can further involve using additional cooling to optimize adhesive bead height for forming the desired width of the air gap. When applying an adhesive layer (e.g., at an adhesive application station as described herein, though other application mechanisms can be used), the glue bead begins to cool in the ambient environment as soon as it is ejected from the nozzle. A method of cooling can thus involve a dwell time (the time between the application of each layer) where an adhesive layer is allowed time to cool in the ambient surrounding environment E prior to application of the next adhesive layer or prior to being indexed to the next adhesive application station.

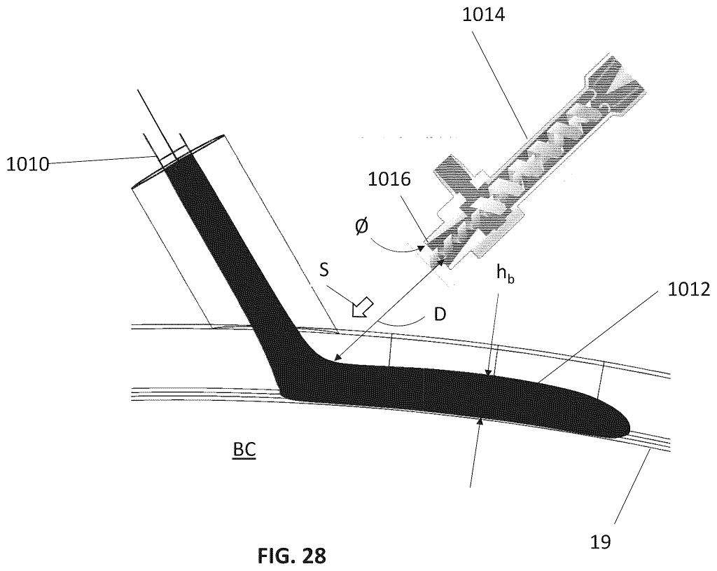

Applying additional forced cooling can accelerate the cooling process to reduce dwell times and improve process control. With reference to FIG. 28, the methods with forced cooling can include directing a cooling air stream S from one or more air applicators 1014 (e.g., a cooling nozzles such as a vortex tube supplied with compressed air) with a tip 1016 spaced a distance D from a localized portion an applied adhesive bead 1012 to create a temperature differential. The resulting bead height h_{b} can be influenced by controlling the independent cooling rates for each applied adhesive layer, taking into account such factors as the type of hotmelt adhesive material, the application temperature, and/or the location of the bead within the band. Individual temperature control for each applied adhesive layer can thus be used to maximize the bead height h_{b} for building the air gap while meeting adhesion property requirements. In some embodiments, the air applicator 1014 can correspond to any of the air applicators 867, 869 described above, and the tip 1016 can be a part of the air applicator members 868 described above so that air is applied to a respective layer hotmelt adhesive of any of the embodiments disclosed herein (e.g., the inner layer 998, L1, L3, L5, L7, L10, L13; one or more of the intermediate layers 999, L11, L14, L15; and the outer layer 999, L2, L4, L6, L8, L12, L16).

In some embodiments, the temperature of the cooling air stream S can be used to influence the resulting bead height h_{b} of the applied adhesive bead 1012. Different temperatures of the cooling air stream S can be used for different adhesive beads in the same band (e.g., between individual glue beads in band B1, between individual glue beads in band B2, etc.). The temperature of the cooling air stream S can be controlled using an air regulator, supply valves, chillers, and/or other methods. In some examples, the temperature of the cooling air stream S can be controlled to vary in a range from, for example, approximately 32-70° F. (0.0-21.1° C.). In other examples, the temperature of the cooling air stream S can be controlled to vary in a range from, for example, approximately 32-45° F. (0.0-7.2° C.)

In some embodiments, the distance D between the air applicator 1014 and the adhesive bead 1012 can be used to influence the resulting bead height h_{b} of the applied adhesive bead 1012. Different distances D can be used for different adhesive beads in the same band. The distance D between the air applicator 1014 and the adhesive bead 1012 can be selected, for example, from a range between approximately 0.50-0.75 inches (12.7-19.1 mm). In another example, the distance D can be approximately 0.625 inches (15.9 mm) or another suitable distance so as to achieve maximum height of the adhesive bead 1012.

In some embodiments, the diameter Ø of the tip 1016 of the air applicator 1014 can be used to influence the resulting bead height h_{b} of the applied adhesive bead 1012. Different diameters Ø of the tip 1016 can be used for different adhesive beads in the same band. The diameter Ø of the tip 1016 of the air applicator 1014 can be, for example, in a range from approximately 0.008-0.020 inches (0.20-0.51 mm).

In some embodiments, the dwell time between applied adhesive layers can be used to influence the resulting bead height h_{b} of the applied adhesive bead 1012. The dwell time between applied adhesive layers can be selected based on, for example, the type of hotmelt adhesive to be applied, the temperature and pressure of the cooling air stream S, and/or other factors. Different dwell times can be used for different adhesive beads in the same band. For example, in some embodiments, the dwell time between layers can be greater than 10 seconds. In other embodiments, the dwell time between layers can be selected from a range between approximately 2 seconds and approximately 6 seconds, but this time may vary outside of this range without departing from the disclosure.

In some embodiments, the method steps including forced cooling can further comprise cooling individual adhesive layers through interval cooling. Interval cooling can include indexing a base container BC between adhesive application stations and a introducing a certain dwell time between the layers applied at each station. A cooling air stream S is used to force cool adhesive layers after application in a fixed interval location. The cooling air stream S can be supplied by, for example, cooling stations indexed with or near the adhesive application stations as described herein. The increase in cooling rate of the adhesive bead 1012 from interval cooling can result in, for example, adhesive bead 1012 with a bead height h_{b} that is at least 6% greater than if the adhesive head had been allowed to cool in the surrounding ambient environment E.

In some embodiments, the method steps including forced cooling can also comprise cooling individual adhesive layers through continuous cooling. Continuous cooling can include the continuous rotation of, and the continuous application of forced cooling to, a base container BC throughout the adhesive application and layering process. The base container is rotated on a supporting mandrel while an adhesive layer is applied, as disclosed herein. During application a stream of air S is directed at the point of application on the surface of the base container BC from one or more air applicators 1014. The BC is made to rotate continuously through both the application of each adhesive bead 1012 and through the subsequent dwell time between beads while the forced cooling is applied. In some examples, the increase in cooling rate of the adhesive bead 1012 from continuous cooling can result in an adhesive bead 1012 with a bead height h_{b} that is at least 30% greater than if the adhesive head had been allowed to cool in the surrounding ambient environment E. In further examples, the increase in cooling rate of the adhesive bead 1012 from continuous cooling can result in an adhesive bead 1012 with a bead height h_{b} that is at least 35% greater than if the adhesive head had been allowed to cool in the surrounding ambient environment E.

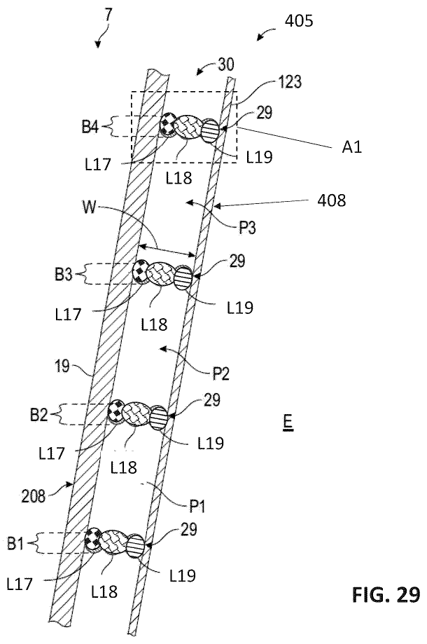

Referring to FIG. 29, employing one or more of the above-disclosed methods and techniques, a container 405 can have a sidewall construct 408 comprising bands B1, B2, B3, B4 each with three layers of adhesive L17, L18, and L19 between the inner sidewall 19 and the overwrap or outer sleeve 123. One or more portions of the container 405 are substantially similar to that of the embodiment of containers 5, 105, 205, and 305 of the disclosure, and like or similar reference numbers will refer to such like or similar elements. The container 405 can have insulating features for maintaining a temperature of a fluid in the interior space 7.

In the embodiment of FIG. 29, the inner layer of adhesive L17 is in contact with the inner sidewall 19, the intermediate middle layer L18 of adhesive is adjacent and in contact with the inner layer of adhesive L17, and the outer layer of adhesive L19 is adjacent and in contact with the intermediate middle layer of adhesive L18 and the outer sleeve 123. The combined width of the three layers of adhesive L17, L18, L19 in the cavity 30 between the inner sidewall 19 to the outer sleeve 123 comprises the spacing or width W of the pockets P1, P2, P3 of the insulating features forming the air gap of the container 405. The insulating features and the container 405 could be otherwise shaped, arranged, and/or configured without departing from the disclosure. Layers of adhesive L17, L18, L19 are applied so as to maximize width W while maintaining strong bonding and minimizing the mass of adhesive used.

For example, layers of adhesive L17, L18, L19 can be formed from at least two different hotmelt adhesives having distinct application temperatures and viscosities. In some embodiments, the inner layer of adhesive L17 and the outer layer of adhesive L19 (the “outer layers” with respect to forming the air gap in the cavity 30) are formed from higher temperature hotmelt adhesive materials (e.g., Supra 614, Supra 128, and/or another material) to achieve desired wetting and a stronger bond between the inner layer of adhesive L17 and the inner sidewall 19 and the outer layer of adhesive L19 and the outer sleeve 123. The outer layers L17, L19 can be formed from the same adhesive material or a different adhesive material. In some embodiments, the outer layers L17, L19 can have an application temperature in a range from approximately 280-310° F. (137.8-154.4° C.) and an application pressure in a range from approximately 30-80 psi (206.8-551.6 kPa), although other temperatures and pressures can be used without departing from the disclosure. In one embodiment, the inner layer of adhesive L17 is first applied to the inner sidewall 19, the intermediate layer is then applied to the inner layer of adhesive L17, the outer layer of adhesive L19 is then applied to the intermediate layer of adhesive L18, and the outer sleeve 123 is applied top the outer layer L19 of material.

The intermediate middle layer of adhesive L18 can be formed from a lower temperature adhesive materials (e.g., Supra 450 or another suitable material with a lower glass transition temperature than the adhesive materials used for layers L17 and L19) to achieve a taller glue bead height h_{b} for forming the desired width W of the air gap in container 405. Intermediate middle layer of adhesive L18 can have an application temperature of approximately 220° F./104.4° C.) and an application pressure in a range from approximately 30-80 psi (206.8-551.6 kPa), although other temperatures and pressures can be used without departing from the disclosure.

In some embodiments, one or more layers of adhesive L17, L18, L19 can be applied from a nozzle positioned at an angle A offset from direction N perpendicular to the tangent T of the surface arc of the inner sidewall 19 (see FIG. 26B). For example, layer L17 can be applied to the inner sidewall 19 at an angle A, layer L18 can be applied to layer L17 at an angle A that is the same or different than the angle used to apply layer L17, and layer L19 can be applied to layer L18 at an angle A that is the same or different than the angle used to apply layers L17 and L18, respectively.

In some embodiments, one or more layers of adhesive L17, L18, L19 can be applied with forced cooling, such as interval cooling or continuous cooling, for example, as described herein. The methods can also include a dwell time between the application of one or more of layers of adhesive L17, L18, L19.

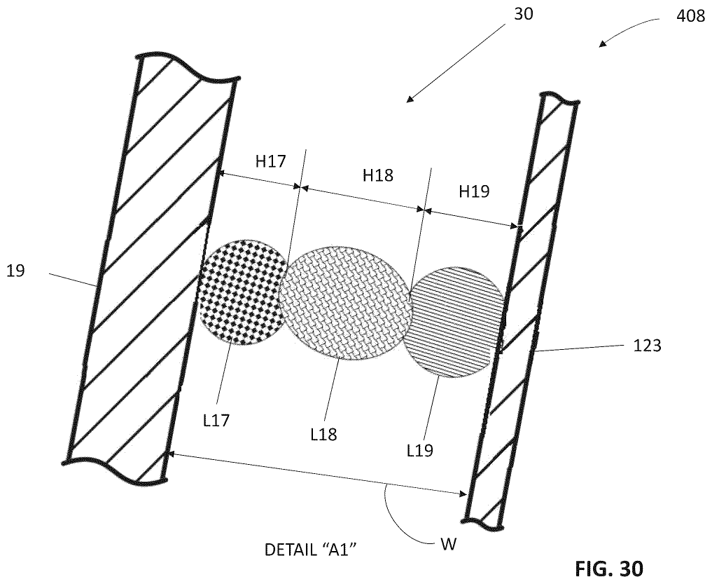

FIG. 30 shows detail “A1” from FIG. 29. The methods described can result in the formation of layers of adhesive L17, L18, L19 having bead heights h_{b} of H17, H18, and H19 respectively. Collectively, the addition of H17, H18, and H19 can equal the width W of the air gap of the container 405. As described previously, the height of each bead can depend on factors such as the type of adhesive material, the application rate and temperature, the application angle, the cooling rate, and the dwell time. The height H18 of intermediate middle layer L18 can be maximized relative to the outer layers L17, L19 as layer L18 does not require the temperature or viscosity to bond with a substrate. Thus, H18 can be greater than one or both of H17 and H19. Maximizing height H18 can thus allow for a greater width W of the air gap for the same amount of adhesive used.

The container 405 can include a similar closed bottom as described and illustrated herein for containers 205 and 305 in that the container 405 is also scalable with the bottom panel positionable at various distances from the lower edge of the container 405. The container 405 could have other bottom features without departing from the disclosure.

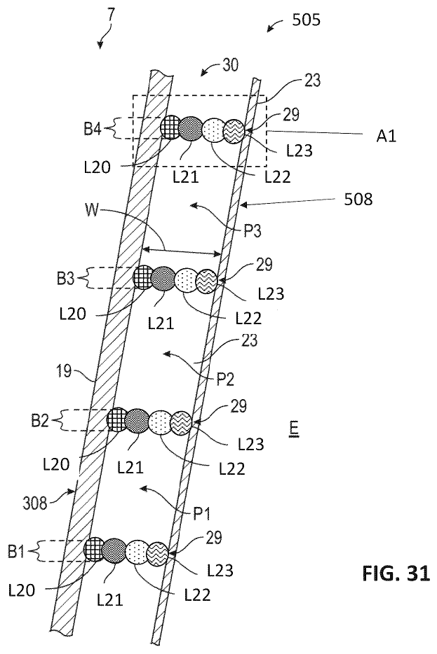

Referring to FIG. 31, in another embodiment a container 505 can have a sidewall construct 508 comprising bands B1, B2, B3, B4 each with four layers of adhesive L20, L21, L22, and L23 between the inner sidewall 19 and the overwrap or outer sleeve 23, 123. One or more portions of the container 505 are substantially similar to that of the embodiment of containers 5, 105, 205, 305, and 405 of the disclosure, and like or similar reference numbers will refer to such like or similar elements. The container 505 can have insulating features for maintaining a temperature of a fluid in the interior space 7.

In the embodiment of FIG. 31, the inner layer of adhesive L20 is in contact with the inner sidewall 19, the first intermediate middle layer L21 of adhesive is adjacent and in contact with the inner layer of adhesive L20, the second intermediate middle layer L22 of adhesive is adjacent and in contact with the first intermediate middle layer of adhesive L21, and the outer layer of adhesive L23 is adjacent and in contact with the second intermediate middle layer of adhesive L22 and the outer sleeve 123. The combined width of the four layers of adhesive L20, L21, L22, L23 in the cavity 30 between the inner sidewall 19 to the outer sleeve 123 comprises the spacing or width W of the pockets P1, P2, P3 of the insulating features forming the air gap of the container 505. The insulating features and the container 505 could be otherwise shaped, arranged, and/or configured without departing from the disclosure. Layers of adhesive L20, L21, L22, L23 are applied so as to maximize width W while maintaining strong bonding and minimizing the mass of adhesive used.

For example, layers of adhesive L20, L21, L22, L23 can be formed from at least two different hotmelt adhesives having distinct application temperatures and viscosities. In some embodiments, the inner layer of adhesive L20 and the outer layer of adhesive L23 (the “outer layers” with respect to forming the air gap in the cavity 30) are formed from higher temperature adhesive materials (e.g., Supra 614, Supra 128, and/or another material) to achieve desired wetting and a stronger bond between the inner layer of adhesive L20 and the inner sidewall 19 and the outer layer of adhesive L23 and the outer sleeve 123. The outer layers L20, L23 can be formed from the same adhesive material or a different adhesive material. In some embodiments, the outer layers L20, L23 can have an application temperature in a range from approximately 280-310° F. (137.8-154.4° C.) and an application pressure in a range from approximately 30-80 psi (206.8-551.6 kPa), although other temperatures and pressures can be used without departing from the disclosure.

The first and second intermediate middle layers of adhesive L21, L22 can be formed from a lower temperature adhesive material or materials (e.g., Supra 450 or other suitable materials with a lower glass transition temperature than the adhesive materials used for layers L20 and L23) to achieve a taller glue bead height h_{b} for forming the desired width W of the air gap in container 505. In some embodiments, intermediate middle layers of adhesive L21, L22 are formed from the same lower temperature hotmelt material. In other embodiments, intermediate middle layers of adhesive L21, L22 are formed from different lower temperature hotmelt materials. Intermediate middle layers of adhesive L21, L22 can have an application temperature of approximately 220° F./104.4° C.) and an application pressure in a range from approximately 30-80 psi (206.8-551.6 kPa), although other temperatures and pressures can be used without departing from the disclosure.

In some embodiments, one or more of layers of adhesive L20, L21, L22, L23 can be applied from a nozzle positioned at an angle A offset from direction N perpendicular to the tangent T of the surface arc of the inner sidewall 19 (see FIG. 26B). For example, layer L20 can be applied to the inner sidewall 19 at an angle A, layer L21 can be applied to layer L20 at an angle A that is the same or different than the angle used to apply layer L20, layer L22 can be applied to layer L21 at an angle A that is the same or different than the angles used to apply layers L20 and L21, and layer L23 can be applied to layer L22 at an angle A that is the same or different than the angles used to apply layers L20, L21, and L22, respectively.

In some embodiments, one or more of layers of adhesive L20, L21, L22, L23 can be applied with forced cooling, such as interval cooling or continuous cooling, for example, as described herein. The methods can also include a dwell time between the application of one or more of layers of adhesive L20, L21, L22, L23.

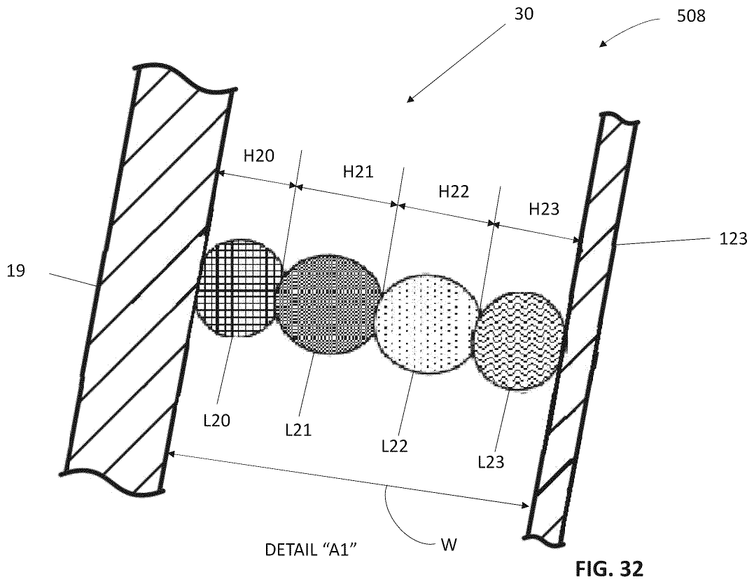

Referring to FIG. 32, the methods can result in the formation of layers of adhesive L20, L21, L22, L23 having bead heights h_{b} of H20, H21, H22, and H23 respectively. Collectively, the addition of H20, H21, H22, and H23 can equal the width W of the air gap of the container 505. As described previously, the height of each bead can depend on factors such as the type of adhesive material, the application rate and temperature, the application angle, the cooling rate, and the dwell time. The heights H21, H22 of intermediate middle layers L21, L22 can be maximized relative to the outer layers L20, L23 as layers L21, L22 do not require the temperature or viscosity to bond with a substrate. Thus, H21 and H22 can be greater than one or both of H20 and H23. Maximizing the height H21, H22 of intermediate middle layers L21, L22 can thus allow for a greater width W of the air gap for the same amount of adhesive used.

The container 505 can include a similar closed bottom as described and illustrated herein for containers 205, 305, and 405 in that the container 505 is also scalable with the bottom panel positionable at various distances from the lower edge of the container 505. The container 505 could have other bottom features without departing from the disclosure.

Although containers 405 and 505 are illustrated in FIGS. 29-32 are shown with three and four layers of adhesive, respectively, a greater number of layers can be used to form the desired air gap. While outer layers L17, L19 of container 405 and outer layers L20, L23 of container 505 are required to form a strong bond with the inner sidewall 19 and the outer sleeve 123, the number of inner intermediate layers can be varied. Although one inner layer (L18) and two inner layers (L21, L22) are shown for containers 405 and 505, respectively, a greater number of inner intermediate layers can be used to form the desired width W of the air gap without departing from the disclosure.

The containers and/or the blanks that form the containers according to the present disclosure can be, for example, formed from coated paperboard and similar materials. For example, the interior and/or exterior sides of the blanks can be coated with a clay coating. The clay coating may then be printed over with product, advertising, price coding, and other information or images. The blanks may then be coated with a varnish to protect any information printed on the blank. The blanks may also be coated with, for example, a moisture barrier layer, on either or both sides of the blank. In accordance with the above-described embodiments, the blanks may be constructed of paperboard of a caliper such that it is heavier and more rigid than ordinary paper. The blanks can also be constructed of other materials, such as cardboard, hard paper, or any other material having properties suitable for enabling the container to function at least generally as described herein. The blanks can also be laminated or coated with one or more sheet-like materials at selected panels or panel sections.

The above embodiments may be described as having one or more portions adhered together by glue during erection of the container embodiments. The term “glue” is intended to encompass all manner of adhesives commonly used to secure containers in place.

The foregoing description of the disclosure illustrates and describes various exemplary embodiments. Various additions, modifications, changes, etc., could be made to the exemplary embodiments without departing from the spirit and scope of the disclosure. It is intended that all matter contained in the above description or shown in the accompanying drawings shall be interpreted as illustrative and not in a limiting sense. Additionally, the disclosure shows and describes only selected embodiments of the disclosure, but the disclosure is capable of use in various other combinations, modifications, and environments and is capable of changes or modifications within the scope of the inventive concept as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A container for containing a cold fluid, comprising:
a sidewall construct comprising an inner sidewall extending at least partially around an interior of the container, an outer sleeve attached to the inner sidewall, and a cavity defined between the inner sidewall and the outer sleeve; and
a closed bottom defining a bottom of the interior of the container,
the container comprises insulating features comprising the cavity and a plurality of annular bands, each annular band of the plurality of annular bands comprises a spacer that extends in the cavity from the inner sidewall to the outer sleeve, the spacer comprises an inner layer of material in adhesive contact with the inner sidewall, an outer layer of material in adhesive contact with outer sleeve, and at least one intermediate layer of material applied between the inner layer and the outer layer, the inner layer and the outer layer comprise a higher temperature hotmelt adhesive and the intermediate layer comprises a lower temperature hotmelt adhesive, and
adjacent bands define a respective pocket of a plurality of pockets in the cavity such that the insulating features maintain a desired temperature of the cold fluid.

2. The container of claim 1, wherein the higher temperature hotmelt adhesive has an application temperature of at least approximately 280° F. (138° C.).

3. The container of claim 1, wherein the lower temperature hotmelt adhesive has an application temperature of at least approximately 220° F. (104° C.).

4. The container of claim 1, wherein the at least one intermediate layer of the spacer is in contact with the inner layer and the outer layer.

5. The container of claim 1, wherein the at least one intermediate layer comprises a first intermediate layer in contact with the inner layer, and a second intermediate layer in contact with the first intermediate layer and the outer layer.

6. The container of claim 1, wherein the spacer has a width between about 60 mils and about 120 mils.

7. The container of claim 1, wherein the spacer has a width between about 80 mils and about 120 mils.

8. The container of claim 1, wherein the spacer has a width of about 80 mils.

9. The container of claim 1, wherein the inner layer is applied to the inner sidewall at a first angle relative to a direction perpendicular to the tangent of the inner sidewall.

10. The container of claim 9, wherein the outer layer is applied to the outer sleeve at the first angle and the intermediate layer is applied to the inner layer at the first angle.

11. The container of claim 9, wherein the first angle is approximately 30 degrees relative to a direction perpendicular to the tangent of the inner sidewall.

12. A sidewall construct for forming a fluid container for containing a cold fluid, the sidewall construct comprising:
an inner sidewall extending at least partially around an interior of the container; an outer sleeve attached to the inner sidewall;
a cavity defined between the inner sidewall and the outer sleeve; and
insulating features comprising the cavity and a plurality of annular bands, each annular band of the plurality of annular bands comprises a spacer that extends in the cavity from the inner sidewall to the outer sleeve, the spacer comprises an inner layer of material in adhesive contact with the inner sidewall, an outer layer of material in adhesive contact with outer sleeve, and at least one intermediate layer of material applied between the inner layer and the outer layer, the inner layer and the outer layer comprise a higher temperature hotmelt adhesive and the intermediate layer comprises a lower temperature hotmelt adhesive, and
adjacent bands define a respective pocket of a plurality of pockets in the cavity for maintaining a desired temperature of the cold fluid.

13. The sidewall construct of claim 12, wherein the higher temperature hotmelt adhesive has an application temperature of at least approximately 280° F. (138° C.).

14. The sidewall construct of claim 12, wherein the lower temperature hotmelt adhesive has an application temperature of at least approximately 220° F. (104° C.).

15. The sidewall construct of claim 12, wherein the at least one intermediate layer of the spacer is in contact with the inner layer and the outer layer.

16. The sidewall construct of claim 12, wherein the at least one intermediate layer comprises a first intermediate layer in contact with the inner layer, and a second intermediate layer in contact with the first intermediate layer and the outer layer.

17. The sidewall construct of claim 12, wherein the spacer has a width between about 60 mils and about 120 mils.

18. The sidewall construct of claim 12, wherein the spacer has a width between about 80 mils and about 120 mils.

19. The sidewall construct of claim 12, wherein the spacer has a width of about 80 mils.

20. The sidewall construct of claim 12, wherein the inner layer is applied to the inner sidewall at a first angle relative to a direction perpendicular to the tangent of the inner sidewall.

21. The sidewall construct of claim 20, wherein the outer layer is applied to the outer sleeve at the first angle and the intermediate layer is applied to the inner layer at the first angle.

22. The sidewall construct of claim 20, wherein the first angle is approximately 30 degrees relative to a direction perpendicular to the tangent of the inner sidewall.

23. A method of forming a container for containing a cold fluid, comprising:
obtaining an inner sidewall and an outer sleeve;
attaching the outer sleeve to the inner sidewall to form a sidewall construct with a cavity defined between the inner sidewall and the outer sleeve, the attaching comprises forming insulating features in the sidewall construct, the insulating features comprise the cavity and a plurality of annular bands, each annular band of the plurality of annular bands comprises a spacer that extends in the cavity from the inner sidewall to the outer sleeve, the spacer comprises an inner layer of material in adhesive contact with the inner sidewall, an outer layer of material in adhesive contact with outer sleeve, and at least one intermediate layer of material applied between the inner layer and the outer layer, the inner layer and the outer layer comprise a higher temperature hotmelt adhesive and the intermediate layer comprises a lower temperature hotmelt adhesive, adjacent bands define a respective pocket of a plurality of pockets in the cavity for maintaining a desired temperature of the cold fluid;
forming an interior of the container by positioning the sidewall construct so that the inner sidewall extends at least partially around the interior; and
positioning a closed bottom relative to the sidewall construct.

24. The method of claim 23, wherein the higher temperature hotmelt adhesive has an application temperature of at least approximately 280° F. (138° C.).

25. The method of claim 23, wherein the lower temperature hotmelt adhesive has an application temperature of at least approximately 220° F. (104° C.).

26. The method of claim 23, wherein the forming the insulating features comprises positioning the at least one intermediate layer of the spacer in contact with the inner layer and the outer layer.

27. The method of claim 23, wherein the at least one intermediate layer comprises a first intermediate layer and a second intermediate layer, the forming the insulating features comprises positioning the first intermediate layer in contact with the inner layer and positioning the second intermediate layer in contact with the first intermediate layer.

28. The method of claim 23, wherein the spacer has a width between about 60 mils and about 120 mils.

29. The method of claim 23, wherein the spacer has a width between about 80 mils and about 120 mils.

30. The method of claim 23, wherein the spacer has a width of about 80 mils.

31. The method of claim 23, wherein the forming the insulating features comprises applying the inner layer to the inner sidewall at a first angle relative to a direction perpendicular to the tangent of the inner sidewall.

32. The method of claim 31, wherein the forming the insulating features comprises applying the outer layer to the intermediate layer at the first angle and the intermediate layer is applied to the inner layer at the first angle.

33. The method of claim 31, wherein the first angle is approximately 30 degrees relative to a direction perpendicular to the tangent of the inner sidewall.

34. The method of claim 23, further comprising applying air to each of the first layer of material, the at least one intermediate layer of material, and the outer layer of material.

35. The method of claim 23, wherein the applying air to the respective layer of the spacer comprises providing a respective air applicator and discharging cooling air from the respective air applicator.

36. The method of claim 35, wherein the respective air application has a discharge nozzle having a diameter, the diameter being in the range of approximately 0.008 to 0.020 inches (0.20 to 0.51 mm.
